(19) United States
(12) Patent Application Publication
(10) Pub. No.: US 2019/0014321 A1
(43) Pub. Date: Jan. 10, 2019

(54) DECODER, ENCODER AND METHODS FOR CODING A SEQUENCE OF PORTIONS OF MEDIA FROM/INTO A DATA STREAM USING AN UNARY CODE

(71) Applicant: Fraunhofer-Gesellschaft zur Foerderung der angewandten Forschung e.V., Munich (DE)

(72) Inventors: Joachim KEINERT, Nuernberg (DE); Thomas RICHTER, Berlin (DE); Herbert THOMA, Erlangen (DE); Christian SCHERL, Uttenreuth (DE); Manuel DE FRUTOS LÓPEZ, Nuernberg (DE); Siegfried FOESSEL, Erlangen (DE); Miguel Angel MARTINEZ DEL AMOR, Nuernberg (DE)

(21) Appl. No.: 15/643,799

(22) Filed: Jul. 7, 2017

(51) Int. Cl. H04N 19/13; H04N 19/103; H04N 19/11; H04N 19/184; H04N 19/159; H04N 19/196

(52) U.S. Cl. CPC H04N 19/13; H04N 19/103; H04N 19/196; H04N 19/184; H04N 19/159; H04N 19/11

(57) ABSTRACT

Embodiments of the invention concern coders, e.g. a decoder for decoding a sequence of portions of media from a data stream. The decoder is configured to decode, for a current portion, a signed integer variable from the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs from a second length of a second codeword of the unary code assigned to a second possible value having a second sign and the predetermined absolute value, or being zero with the predetermined absolute value being one, by exactly one. The decoder is further configured to derive a bit plane number predictor for the current portion, to derive a bit plane number indicating coded bit-planes by computing a sum of the bit plane number predictor and the signed integer variable, and to decode the current portion from the data stream by use of the bit plane number.

The invention concerns a decoder for decoding a sequence of portions of media from a data stream using an unary code, an encoder for encoding a sequence of portions of media into a data stream using an unary code, a method for decoding a sequence of portions of media from a data stream using an unary code, a method for encoding a sequence of portions of media into a data stream using an unary code, wherein in some embodiments asymmetric unary alphabets for most significant bit plane position entropy coding of coefficient groups are used.

Compression of an image or a video sequence typically consists of a frequency transform, followed by quantization and entropy coding. In the latter, coefficients are grouped into coefficient groups, and their most significant non-null bitplane (GCLI) is computed. GCLIs are transmitted to the decoder along with the raw data.

In order to encode the GCLIs, the number of remaining bits is calculated according to a truncation level (GTLI), and predicted from either a vertical or horizontal coefficient group. Finally, a variable-length unary code may be used to construct the final bitstream.

The employed alphabet for this unary code is symmetric with respect to 0, investing the same bits for coding a value X and −X. However, the commonly used unary codes for coding require a large number of bits.

Thus, it is an object of the invention to provide more efficient coders and coding schemes which allow for a bit saving compared to the prior art.

A first aspect of the invention concerns a decoder for decoding a sequence of portions of media from a data stream, wherein the decoder is configured to decode, for a current portion, a signed integer variable from the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs from a second length of a second codeword of the unary code assigned to a second possible value by exactly one. Said second possible value has a second sign and the predetermined absolute value, or said second possible value is zero and the predetermined absolute value is one. The decoder is further configured to derive a bit plane number predictor for the current portion, to derive a bit plane number indicating coded bit-planes by computing a sum of the bit plane number predictor and the signed integer variable, and to decode the current portion from the data stream by use of the bit plane number.

A second aspect of the invention concerns an encoder for encoding a sequence of portions of media into a data stream, wherein the encoder is configured to derive a bit plane number predictor for a current portion. The inventive encoder is further configured to derive a bit plane number indicating coded bit-planes for the current portion and setting a signed integer variable so that the bit plane number is derivable from a sum between the bit plane number predictor and the signed integer variable. The inventive encoder is further configured to encode, for the current portion, the signed integer variable into the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs by exactly one from a second length of a second codeword of the unary code assigned to a second possible value. Said second possible values has a second sign and the predetermined absolute value, or said second possible value is zero and the predetermined absolute value is one. The inventive encoder is further configured to encode the current portion into the data stream by use of the bit plane number.

A third aspect of the invention concerns a method for decoding a sequence of portions of media from a data stream, wherein the method comprises a step of decoding, for a current portion, a signed integer variable from the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs by exactly one from a second length of a second codeword of the unary code assigned to a second possible value. Said second possible value has a second sign and the predetermined absolute value, or said second possible value is zero and the predetermined absolute value is one. The method further comprises a step of deriving a bit plane number predictor for the current portion, deriving a bit plane number indicating coded bit-planes by computing a sum of the bit plane number predictor and the signed integer variable, and decoding the current portion from the data stream by use of the bit plane number.

A fourth aspect of the invention concerns a method for encoding a sequence of portions of media into a data stream, wherein the method comprises a step of deriving a bit plane number predictor for a current portion. The method further comprises a step of deriving a bit plane number indicating coded bit-planes for the current portion and setting a signed integer variable so that the bit plane number is derivable from a sum between the bit plane number predictor and the signed integer variable. The method further comprises a step of encoding, for the current portion, the signed integer variable into the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs by exactly one from a second length of a second codeword of the unary code assigned to a second possible value. Said second possible values has a second sign and the predetermined absolute value, or said second possible value is zero and the predetermined absolute value is one. The method further comprises a step of encoding the current portion into the data stream by use of the bit plane number.

A fifth aspect of the invention concerns a computer readable digital storage medium having stored thereon a computer program having a program code for performing, when running on a computer, a method for decoding a sequence of portions of media from a data stream, wherein the method comprises a step of decoding, for a current portion, a signed integer variable from the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs by exactly one from a second length of a second codeword of the unary code assigned to a second possible value. Said second possible value has a second sign and the predetermined absolute value, or said second possible value is zero and the predetermined absolute value is one. The method further comprises a step of deriving a bit plane number predictor for the current portion, deriving a bit plane number indicating coded bit-planes by computing a sum of the bit plane number predictor and the signed integer variable, and decoding the current portion from the data stream by use of the bit plane number.

A sixth aspect of the invention concerns a computer readable digital storage medium having stored thereon a computer program having a program code for performing, when running on a computer, a method for encoding a sequence of portions of media into a data stream, wherein the method comprises a step of deriving a bit plane number predictor for a current portion. The method further comprises a step of deriving a bit plane number indicating coded bit-planes for the current portion and setting a signed integer variable so that the bit plane number is derivable from a sum between the bit plane number predictor and the signed integer variable. The method further comprises a step of encoding, for the current portion, the signed integer variable into the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs by exactly one from a second length of a second codeword of the unary code assigned to a second possible value. Said second possible values has a second sign and the predetermined absolute value, or said second possible value is zero and the predetermined absolute value is one. The method further comprises a step of encoding the current portion into the data stream by use of the bit plane number.

Further advantageous embodiments are defined in the dependent claims.

Embodiments of the present invention will be discussed subsequently referring to the enclosed drawings, wherein:

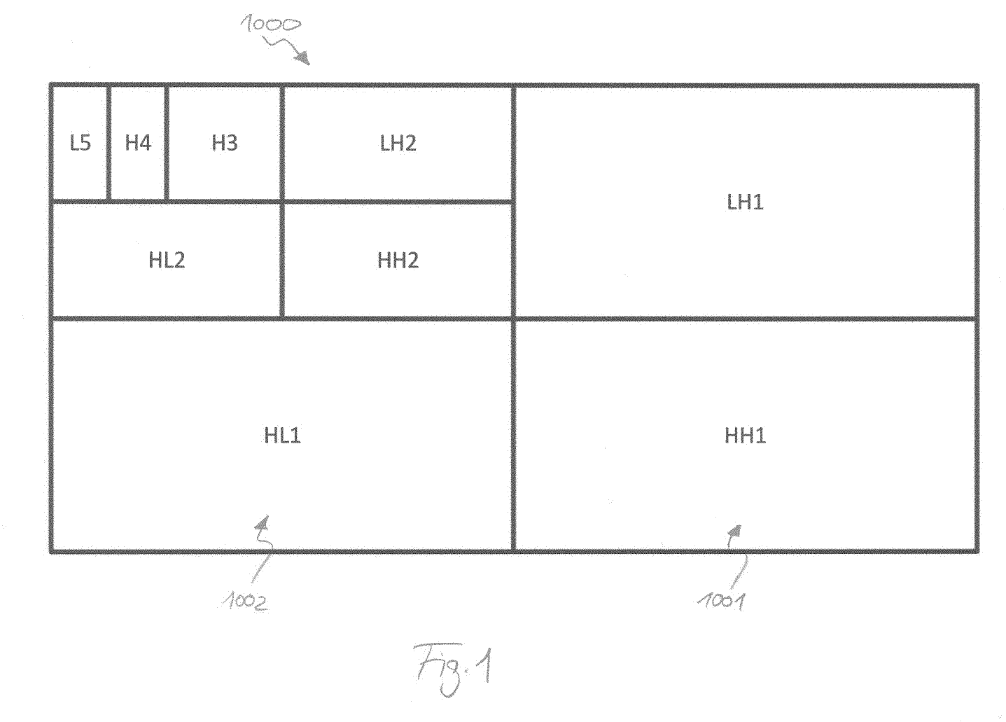

FIG. 1 shows an example of a wavelet transform of an image with here exemplarily two vertical and four horizontal decompositions,

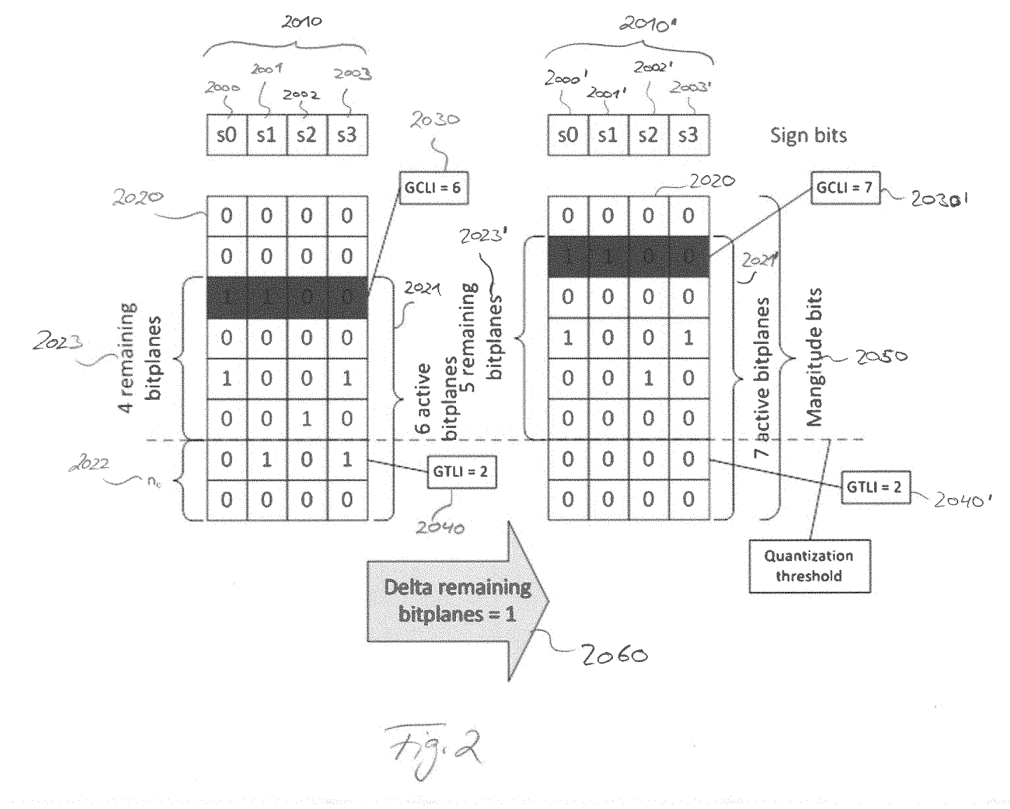

FIG. 2 shows an example of a principle GCLI coding,

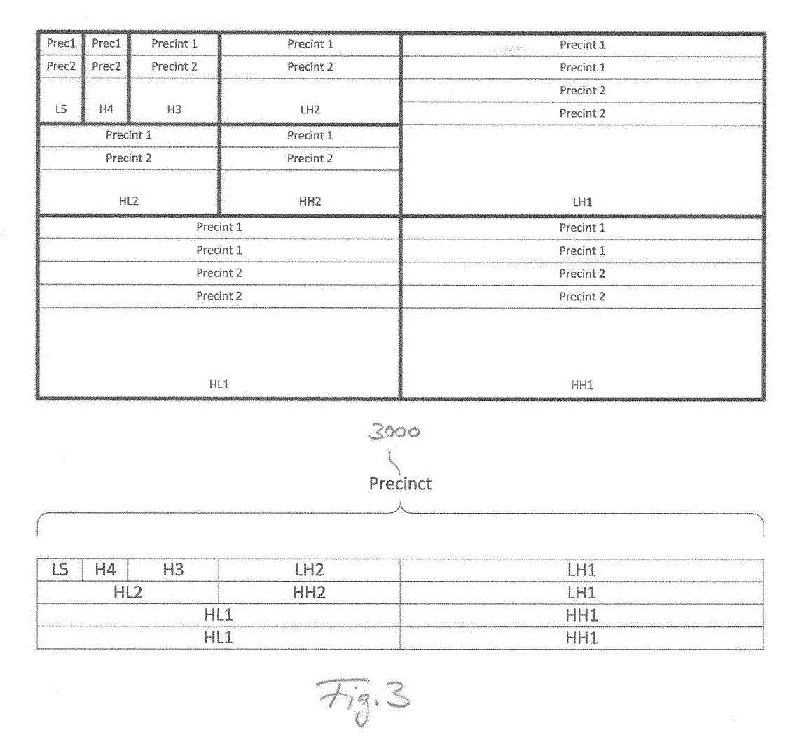

FIG. 3 shows an example of a precinct organization,

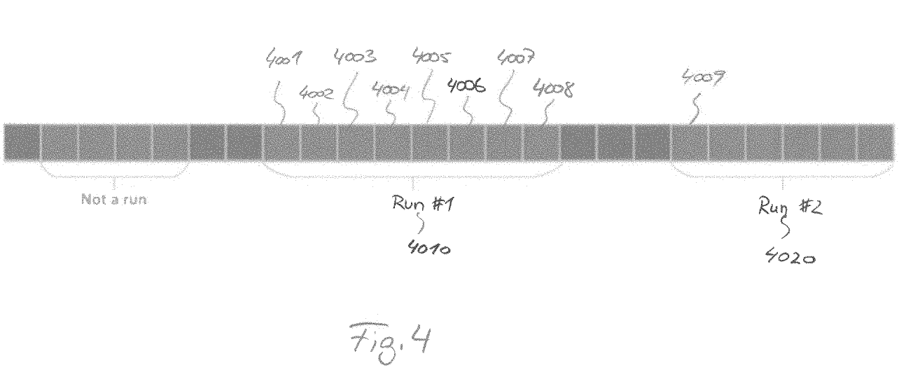

FIG. 4 shows an example of runs of coefficient groups, wherein squares represent the coefficient groups of a subband line, with significant and insignificant groups and a run length being set to eight,

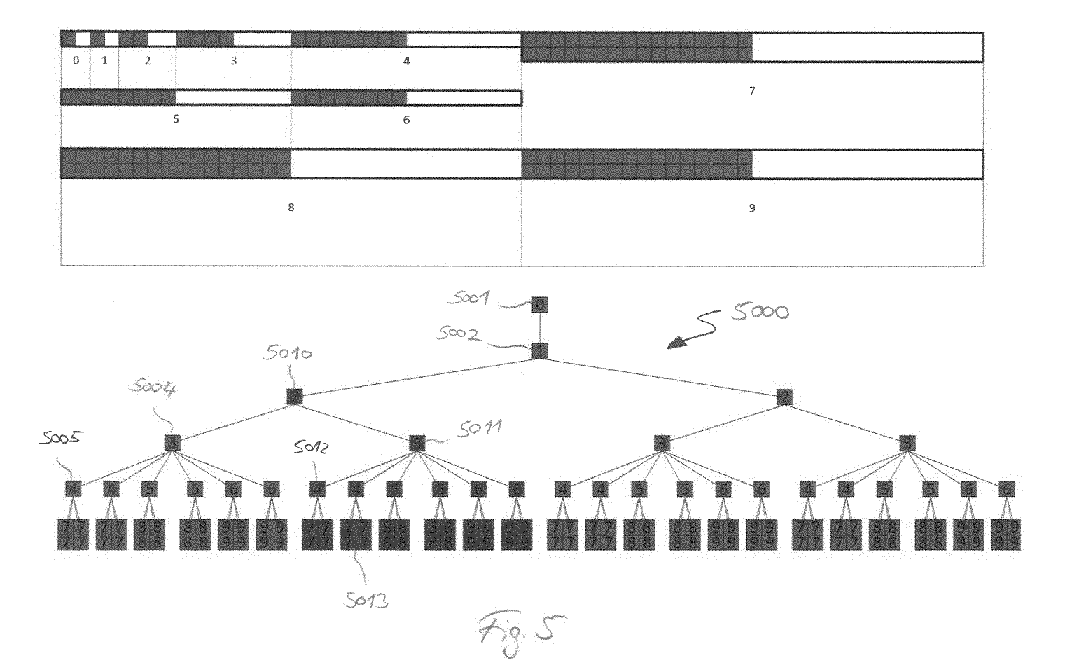

FIG. 5 shows an example of zero-tree coding,

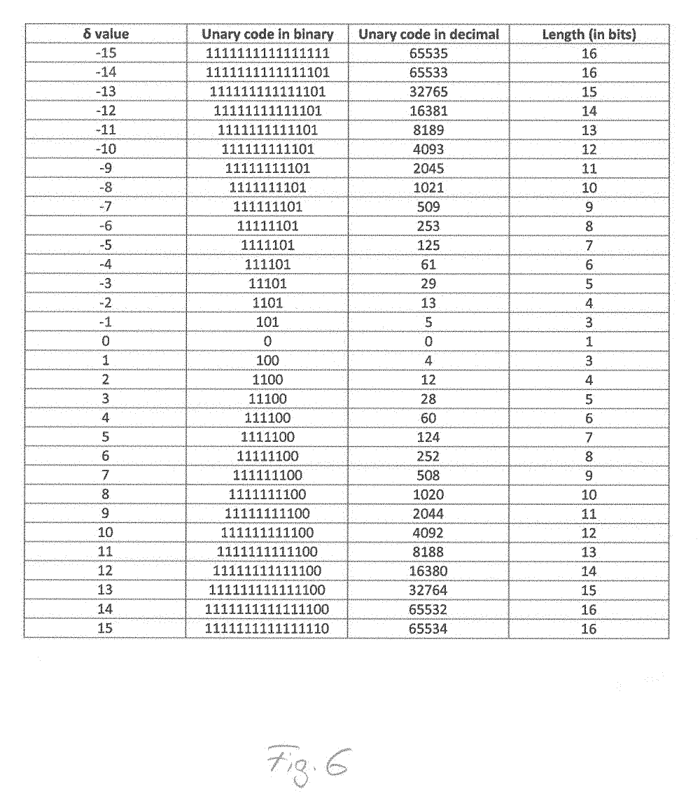

FIG. 6 shows a state of the art alphabet for unary coding of GCLI residuals,

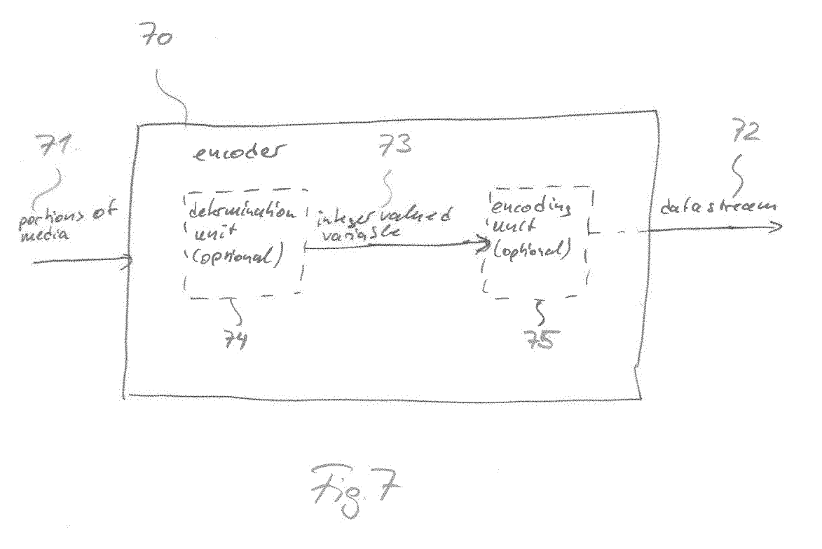

FIG. 7 shows a schematic block diagram of an inventive encoder,

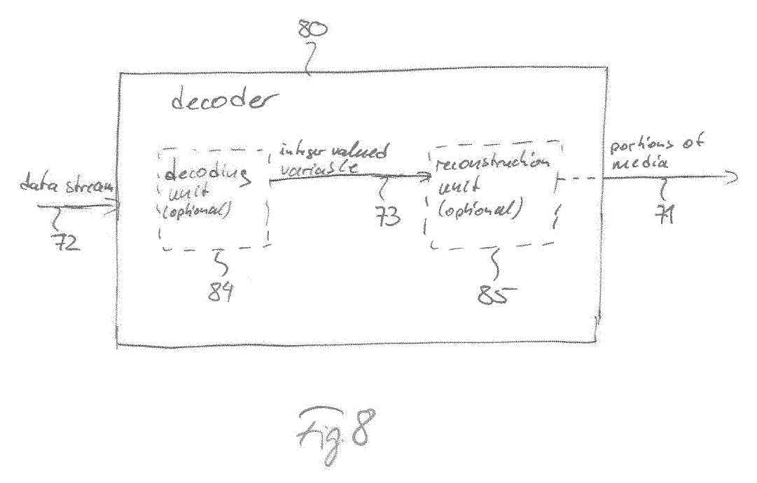

FIG. 8 shows a schematic block diagram of an inventive decoder,

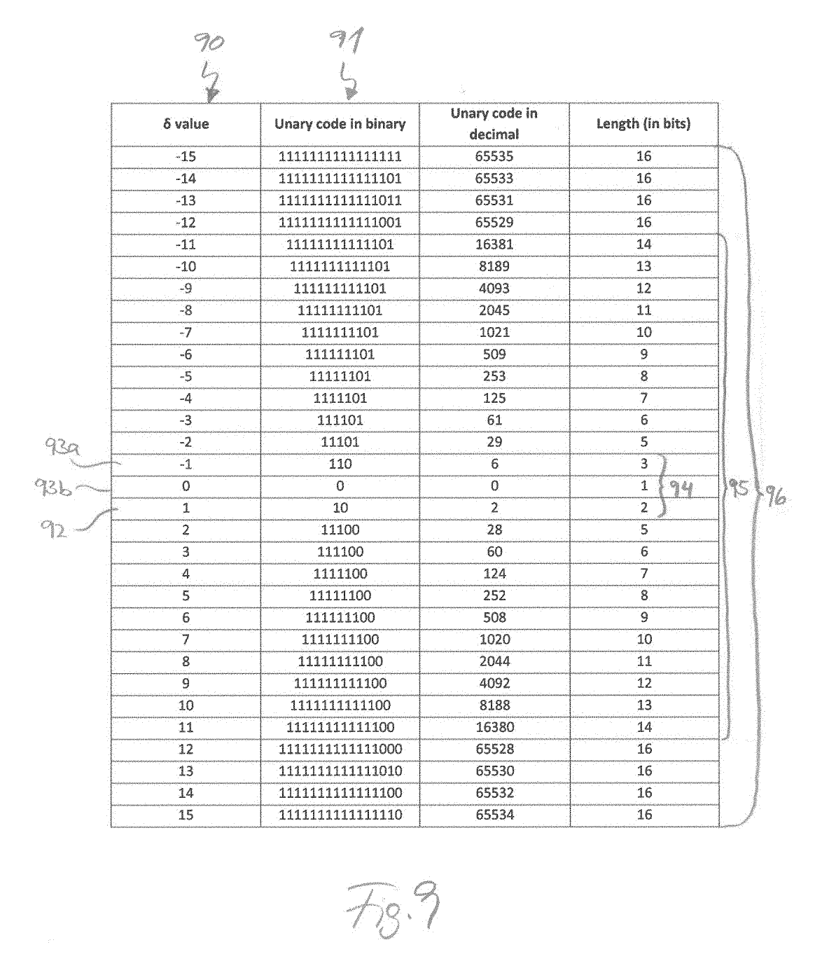

FIG. 9 shows a first full-range alphabet for unary coding that may be used by the inventive coders,

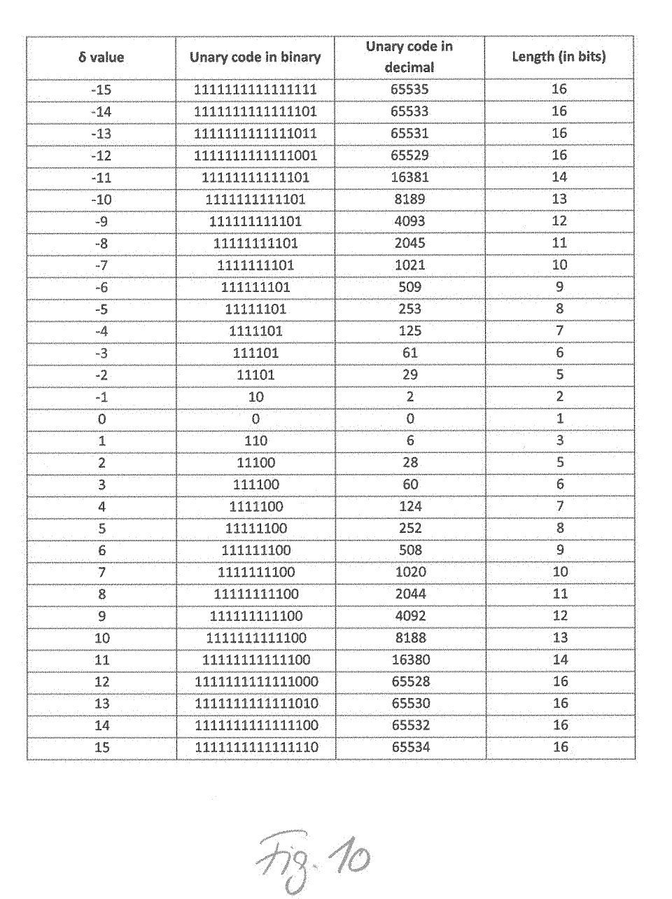

FIG. 10 shows a second full-range alphabet for unary coding that may be used by the inventive coders,

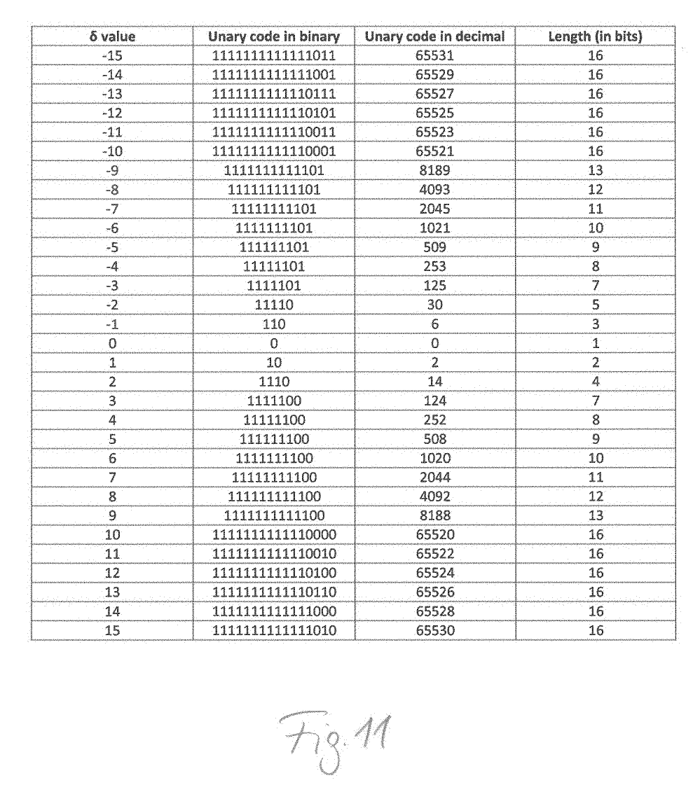

FIG. 11 shows a third full-range alphabet for unary coding that may be used by the inventive coders,

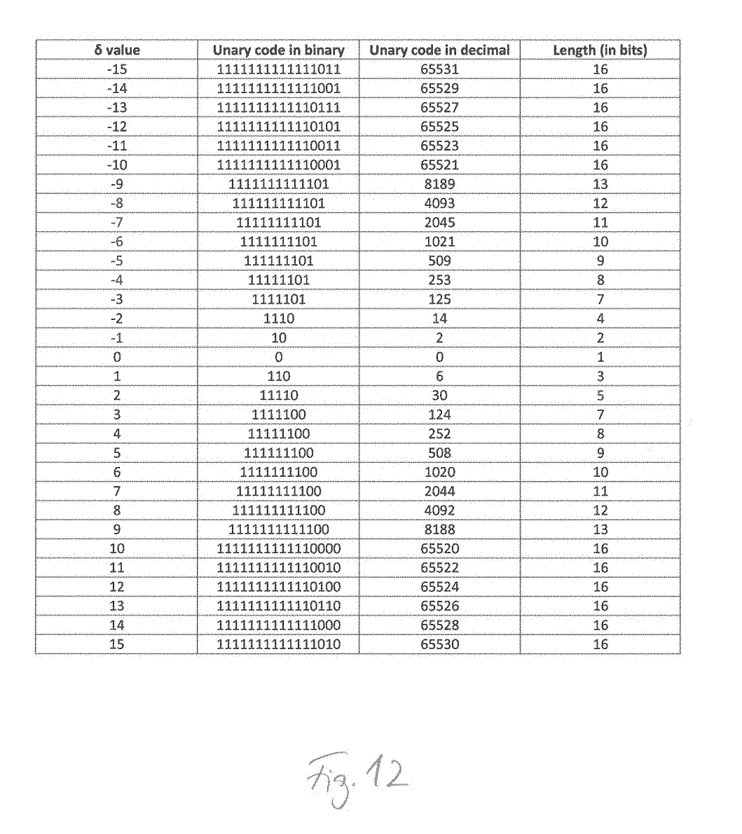

FIG. 12 shows a fourth full-range alphabet for unary coding that may be used by the inventive coders,

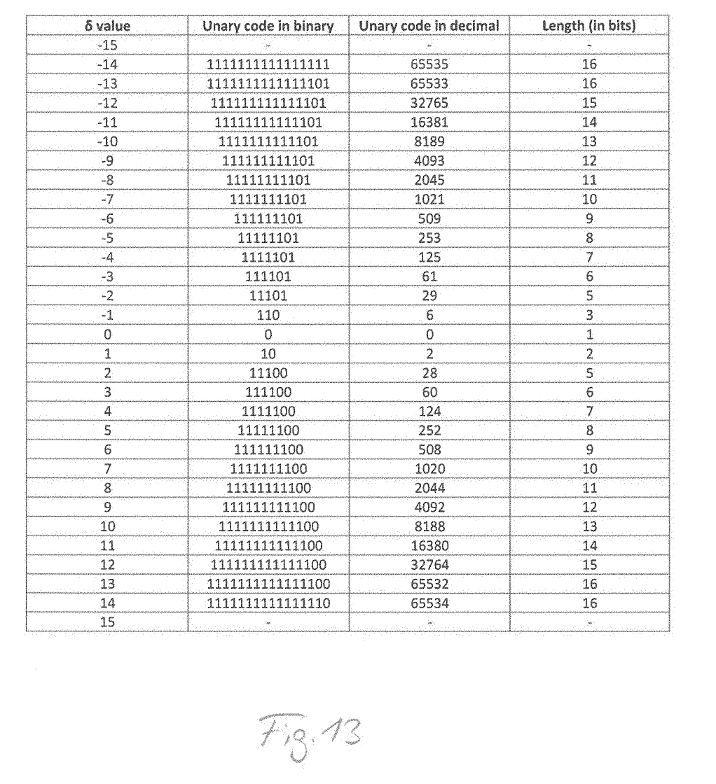

FIG. 13 shows a first clipped signed alphabet for unary coding that may be used by the inventive coders,

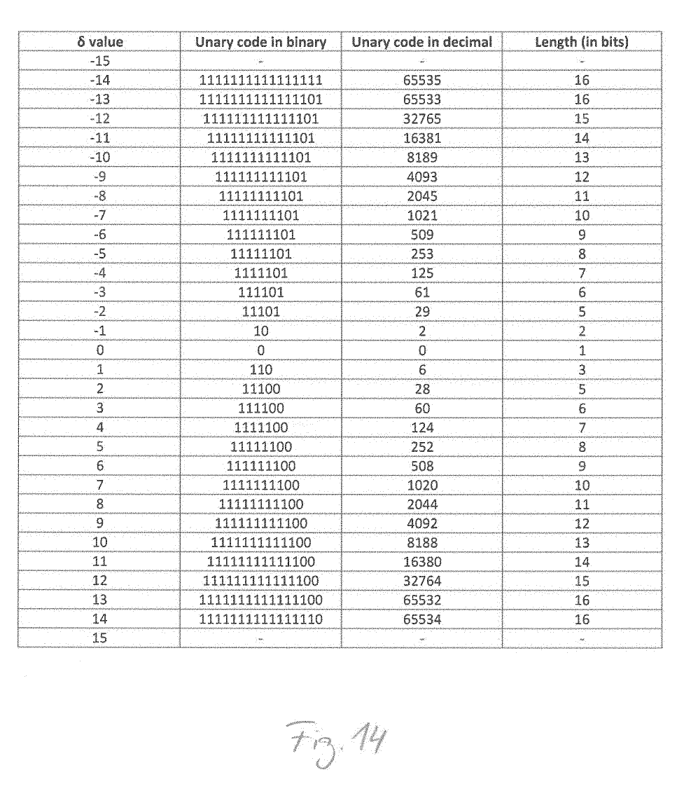

FIG. 14 shows a second clipped signed alphabet for unary coding that may be used by the inventive coders,

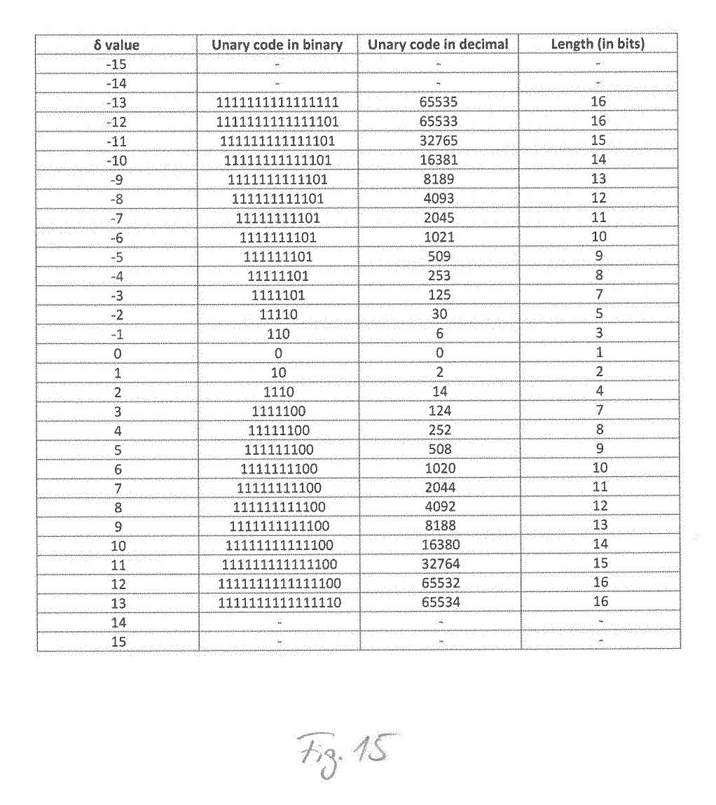

FIG. 15 shows a third clipped signed alphabet for unary coding that may be used by the inventive coders,

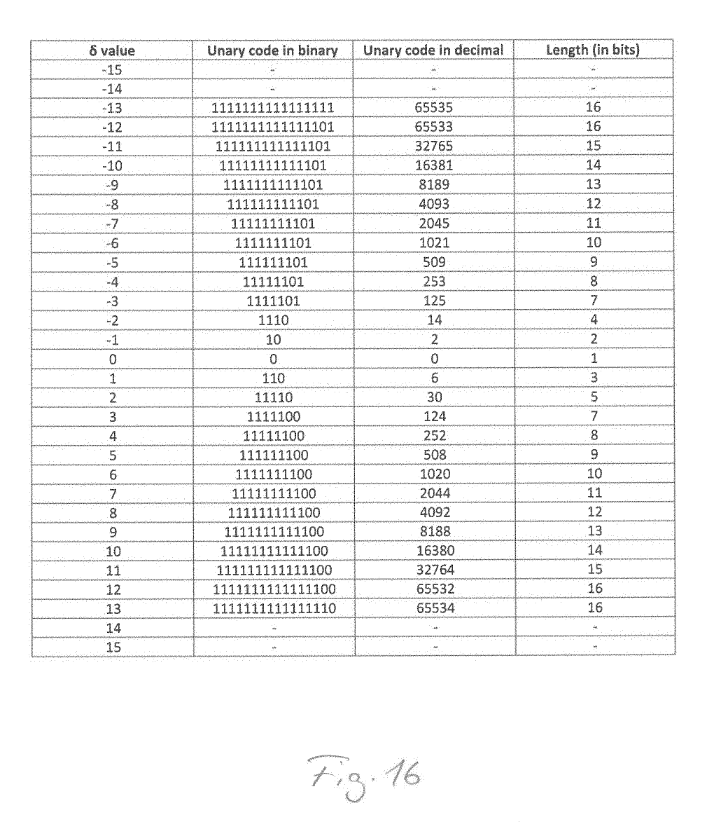

FIG. 16 shows a fourth clipped signed alphabet for unary coding that may be used by the inventive coders,

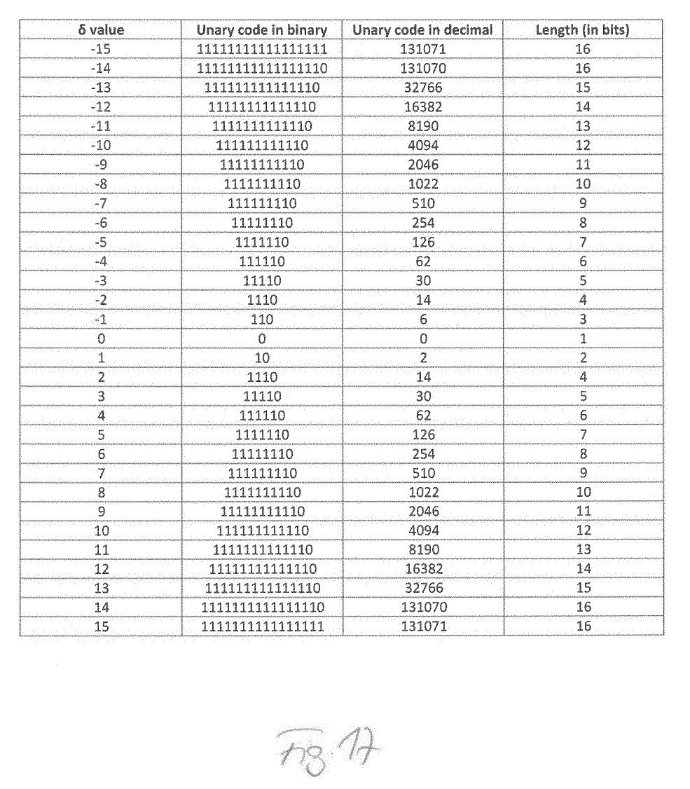

FIG. 17 shows a first full-range unsigned alphabet for unary coding that may be used by the inventive coders,

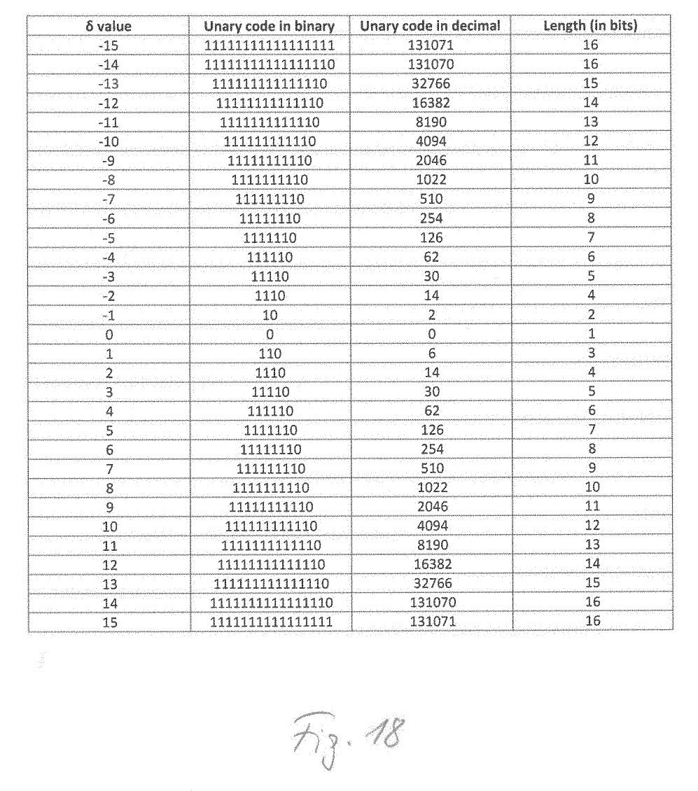

FIG. 18 shows a second full-range unsigned alphabet for unary coding that may be used by the inventive coders,

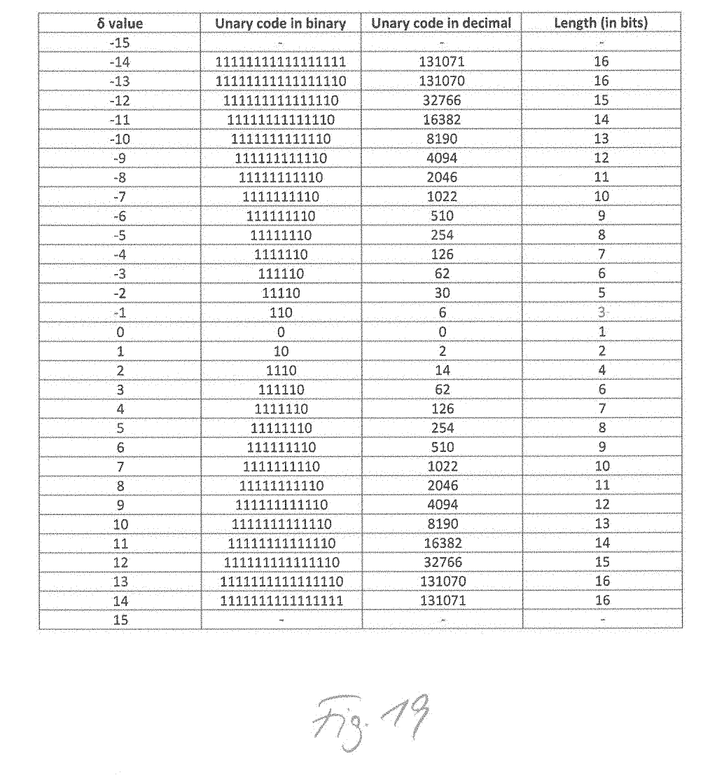

FIG. 19 shows a third clipped unsigned alphabet for unary coding that may be used by the inventive coders,

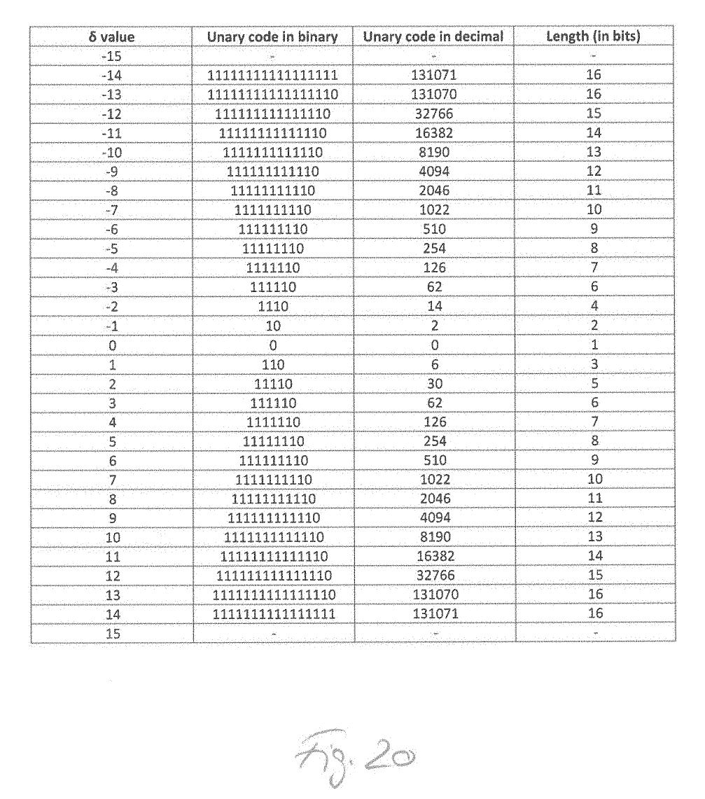

FIG. 20 shows a fourth clipped unsigned alphabet for unary coding that may be used by the inventive coders,

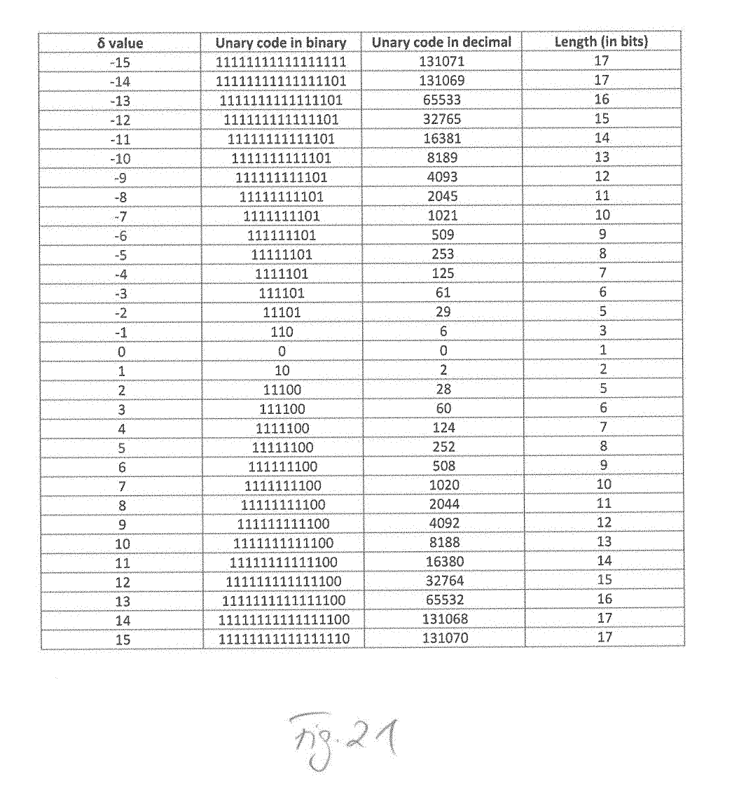

FIG. 21 shows a first extended full-range alphabet for unary coding that may be used by the inventive coders,

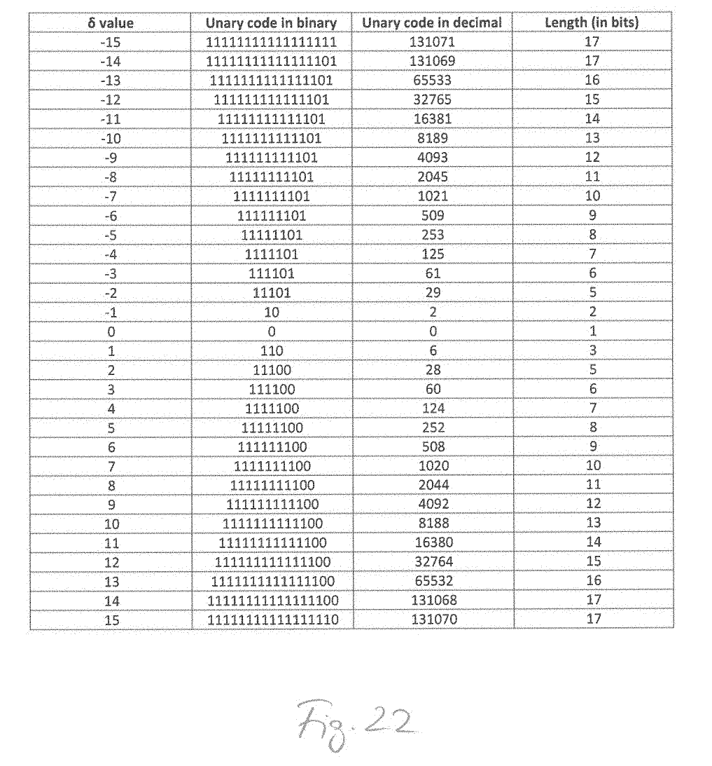

FIG. 22 shows a second extended full-range alphabet for unary coding that may be used by the inventive coders,

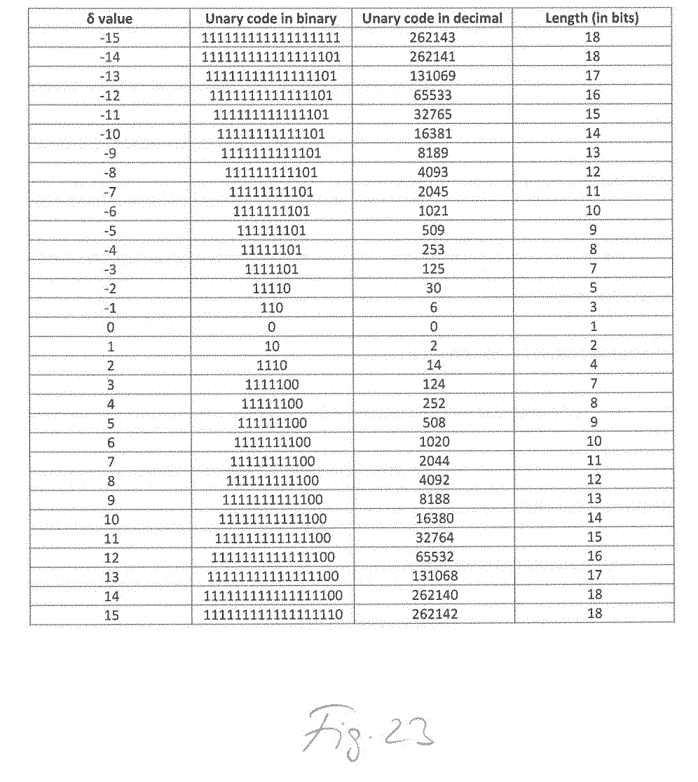

FIG. 23 shows a third extended full-range alphabet for unary coding that may be used by the inventive coders,

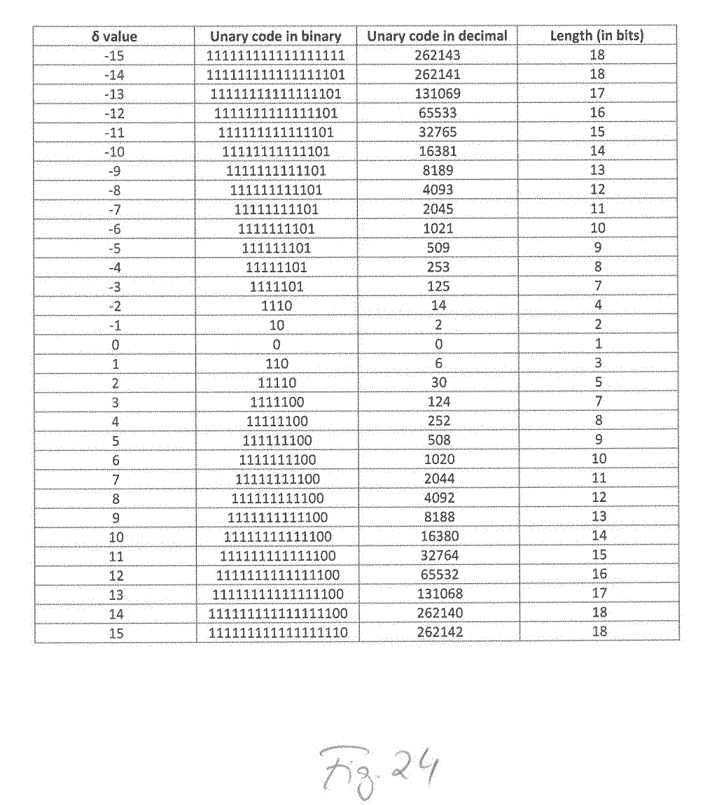

FIG. 24 shows a fourth extended full-range alphabet for unary coding that may be used by the inventive coders,

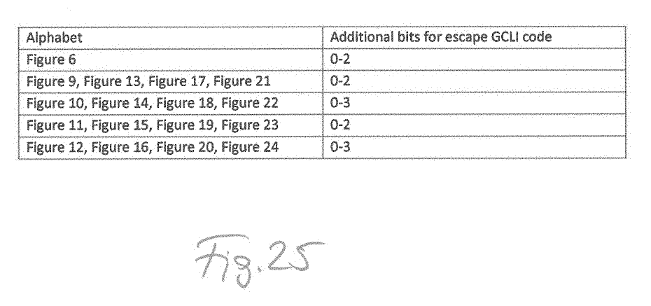

FIG. 25 shows a table indicating the number of additional bits required to emit an escape GCLI code,

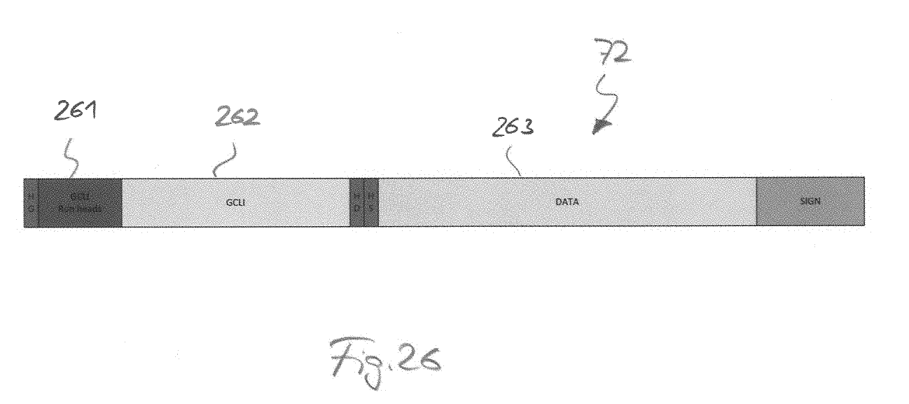

FIG. 26 shows an example of a data stream that may be encoded by the inventive encoder and decoded by the inventive decoder,

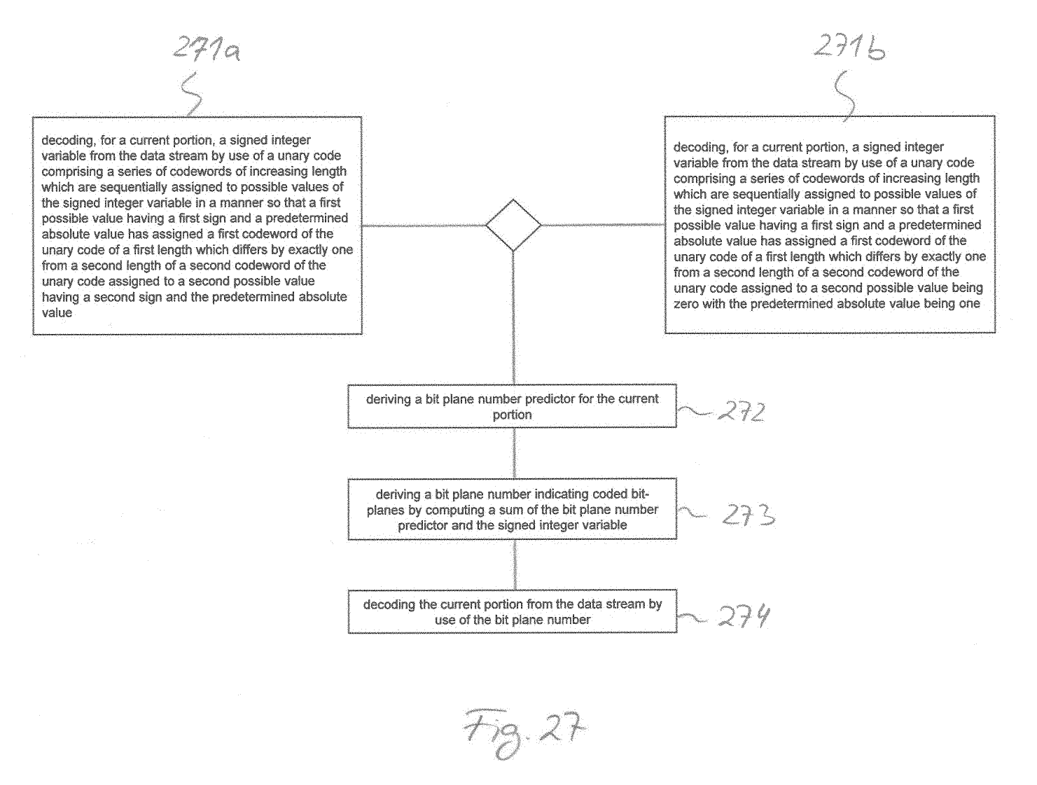

FIG. 27 shows an embodiment of a method for decoding a sequence of portions of media from a data stream, and

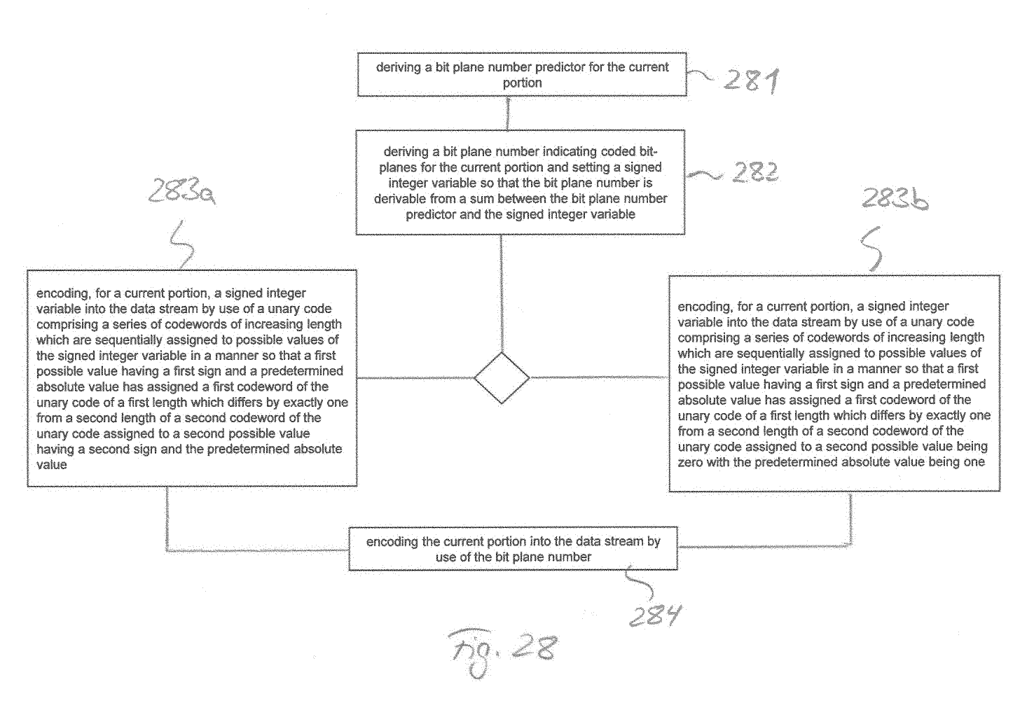

FIG. 28 shows an embodiment of a method for encoding a sequence of portions of media into a data stream.

In the following, embodiments of the invention will be described in further detail. It is to be pointed out that the same or functionally equal elements are given the same reference numbers in the figures and that a repeated description for elements provided with the same reference numbers is omitted. Hence, descriptions provided for elements having the same reference numbers are mutually exchangeable. Furthermore, when referring to both, encoding and decoding, the abbreviation coding is used. Thus, coding refers to both encoding and decoding.

Before the inventive principle will be described in more detail, the following passages provide an introduction to coding schemes and data structures that may be used by the inventive coders and methods for coding.

Image Transform

Image and video compression typically applies a transform before running entropy coding. Reference [5], for instance, uses a block based prediction, while references [1][2][3][4] advocate for wavelet transforms.

Such a wavelet transform is depicted in FIG. 1 that shows a wavelet transform of an image, wherein two vertical and five horizontal decompositions are assumed.

The wavelet transform decomposes an image 1000 into a number of subbands 1001, 1002. As depicted in FIG. 1, the number of horizontal decompositions might be different from the number of vertical decompositions. In each decomposition step, the lowpass subband of the previous decomposition is further decomposed. For example, the L5 subband represents a subsampled version of the image, while the other subbands contain the detail-information.

After the frequency transform, the coefficients of the subbands 1001, 1002 are entropy coded. In other words, g>1 coefficients of a subband ABm, with A,B∈{L,H}, m∈N, are arranged into a coefficient group. Then the most significant non-zero bit plane of the coefficient group is signaled, followed by the raw data bits. More details on the coding technique are explained in the following section.

### Coding Principle

FIG. 2 illustrates the principle of the so-called GCLI coding. A number of coefficients 2000, 2001, 2002, 2003 (being larger than one), belonging to the same subband of a frequency transform, are combined into a group (from now, called coefficient group) 2010.

These coefficients 2000, 2001, 2002, 2003 are represented in sign-magnitude representation. The coefficients 2000, 2001, 2002, 2003 comprise bit planes 2020. The largest coefficient in the group 2010 determines the number of active bit planes 2021.

A bit plane 2020 is called active, if at least one coefficient bit of the bit plane 2020 itself or any higher bit plane (bit plane representing a larger number) is unequal to zero. The number of active bit planes 2021 is given by the so-called GCLI value (Greatest Coded Line Index) 2030. A GCLI value 2030 of zero means that no bit planes 2020 are active, and hence the complete coefficient group 2010 is zero. In order to achieve compression, only the active bit planes 2021 are placed into the bit stream.

For lossy encoding, some of the bit planes 2020 need possibly to be truncated, such that the number of bit planes 2020 transmitted for a coefficient group 2010 is smaller than the GCLI value 2030. This truncation is specified by the so-called GTLI (Greatest Trimmed Line Index) 2040.

A GTLI 2040 of zero corresponds to no truncation. A GTLI value 2040 of one means that the number of transmitted bit planes for a coefficient group 2010 is one less than the GCLI value 2030. In other words, the GTLI 2040 defines the smallest bit plane position that is included in the bit stream.

In case of a simple deadzone quantization scheme, the transmitted bit planes equal the bit planes of the coefficient group 2010 without the truncated bit planes 2022. In case of more advanced quantization schemes, some information of the truncated bit planes 2022 can be “pushed” into the transmitted bit planes by modifying the quantization bins. More details can be found in [6].

Since for each coefficient 2000, 2001, 2002, 2003 the number of remaining bit planes 2023 equals the difference between the GCLI 2030 and the GTLI values 2040, it gets obvious that coefficient groups 2010 whose GCLI 2030 is smaller or equal to the GTLI value 2040 may not be contained in the bit stream.

The active bit planes remaining after truncation and quantization are called remaining bit planes 2023 in the following. Moreover, the GTLI 2040 is also called truncation point in the following.

These remaining bit planes 2023 are then transmitted as raw bits to the decoder. In order to enable correct decoding, the decoder needs to know the GCLI value 2030 of every coefficient group 2010. Together with the GTLI value 2040, which is also signaled to the decoder, the decoder can infer the number of raw data bit planes that are in the bit stream.

FIG. 2 also shows a second coefficient group 2010′ as an example. The second coefficient group 2010′ comprise coefficients 2000′, 2001′, 2002′, 2003′ that are represented in sign-magnitude representation. The coefficients 2000′, 2001′, 2002′, 2003′ comprise bit planes 2020. The largest coefficient in the group 2010′ determines the number of active bit planes 2021′ which is indicated by the GCLI value 2030′.

The GCLI values 2030′ of the second group 2010′ may be signaled by a variable length code (VLC) that represents the difference to the GCLI value 2030 of the previous first coefficient group 2010. This previous coefficient group 2010 can in principle be any coefficient group that the encoder has already encoded before. Hence, it can for instance be a horizontal or a vertical neighbor group.

The output from the prediction is the difference in the number of remaining bit planes 2023, 2023′ between two coefficient groups 2010, 2010′ leading to a delta remaining bit planes 2060. More details on this aspect can be found in the section below called “Prediction Schemes”.

GCLI values 2030 being below the GTLI value 2040 may be of less or even no interest, since the coefficients may not be contained in the bit stream. Consequently, the prediction may be performed in such a way that the decoder can infer whether the GCLI 2030 is greater than the GTLI 2040, and if so, what is the value of the GCLI 2030.

The method described herein is agnostic to the transmission order of the different bit stream parts. For instance, it is possible to first place the GCLI coefficients of all subbands into the bit stream, followed by the data bits of all subbands. Alternatively, GCLI and data bits might be interleaved.

### Coefficient Organization

The coefficients of the frequency transform as previously described with reference to FIG. 1 may be organized in so-called precincts. Said precincts are exemplarily depicted in FIG. 3. Precincts 3000 may allow to group coefficients of different subbands contributing to a given spatial region in the input image.

### Prediction Schemes

In order to enable the decoder to recover the signal, it needs to know the GCLI value 2030 for every coefficient group 2010. Different methods are available in the state of the art [2] to signal them efficiently.

### RAW Mode

In the RAW mode, the GCLI value 2030 is transmitted without any prediction. Hence, let F₁ be the coefficient group 2010′ to be encoded next. Then the GCLI value 2030′ can be encoded by a fixed length codeword representing the value:

max(GCLI(F₁)−GTLI(F₁),0)

### Horizontal Prediction

In a horizontal prediction, the symbol coded is the difference between the GCLI value 2030′ and the value of the GCLI 2030 previously coded belonging to the same line and the same wavelet subband, and considering the GTLI 2040. This difference value is called residual or 5 value in the following.

Let F₁ and F₂ be two horizontally neighbored coefficient groups 2010, 2010′, consisting of g<1 coefficients. Let F₂ be the coefficient group 2010′ to be currently coded. Then GCLI(F₂) can be signaled to the decoder by transmitting a residual calculated as follows:

$$δ = \{ \begin{matrix}max ( GCLI ( {F}_{2} ) , GTLI ( {F}_{2} ) ) - max ( GCLI ( {F}_{1} ) , GTLI ( {F}_{2} ) ) & if GCLI ( {F}_{1} ) > GTLI ( {F}_{1} ) \\ max ( GCLI ( {F}_{2} ) , GTLI ( {F}_{2} ) ) - GTLI ( {F}_{2} ) & otherwise\end{matrix}$$

The decoder recovers GCLI(F₂) by computing

$${GCLI}^{′} ( {F}_{2} ) = δ + \{ \begin{matrix}max ( GCLI ( {F}_{1} ) , GTLI ( {F}_{2} ) ) & if GCLI ( {F}_{1} ) > GTLI ( {F}_{1} ) \\ GTLI ( {F}_{2} ) & otherwise\end{matrix} \\ GCLI ( {F}_{2} ) = \{ \begin{matrix}{GCLI}^{′} ( {F}_{2} ) & if {GCLI}^{′} ( {F}_{2} ) > GTLI ( {F}_{2} ) \\ 0 & otherwise\end{matrix}$$

For instance in horizontal prediction, typically GCLI(F₁)=GCLI(F₂). Furthermore, δ may be transmitted as a variable length code, as described in the section below called “Unary Coding”.

### Vertical Prediction

In a vertical prediction between two subband lines, the result is the difference between the current GCLI value and the GCLI value of the same subset of coefficients in the previously coded line.

Let F₁ and F₂ be two vertically neighbored coefficient groups 2010, 2010′, consisting of g>1 coefficients. Let F₂ be the coefficient group 2010′ to be currently coded. Then, GCLI(F₂) can be encoded in the same way than in the horizontal prediction described above.

### Coding Modes

In addition to the prediction modes, different coding modes can be used. In the following, coding modes are simply considered as additional prediction modes for reasons of simplicity.

### Significance Flags Coding

Reference [6] proposes a method to compress zero GCLIs 2030 more efficiently. To this end, consecutive coefficient groups 2010, 2010′ may be arranged into GCLI groups. All GCLI groups are of the same size (e.g. eight). Then, a single bit flag indicates if the corresponding deltas remaining bit planes 2060 of the complete GCLI group are all zero. Zero GCLI groups may not further be encoded, while non-zero GCLI groups may be encoded as described in the section above called “Prediction Schemes”.

### Spatial Zero-Run Coding

Reference [7] proposes an intrasubband alternative to efficiently compress zero GCLIs 2030. In this method, the decoder is informed that a group (run) of (zero) GCLI values is not contained in the bit stream by signaling a GCLI value that is not used for ordinary coding. For instance, GCLI values 2030 below the GTLI value 2040 are not used for normal coding, since setting GCLI=GTLI already defines a zero coefficient. Hence, signaling a GCLI value 2030 equaling GTLI−1 can also be used to inform the decoder about skipped GCLI coefficients. The GCLI values 2030 used to signal GCLI skipping are called escape GCLI codes in the following.

GCLI zero-run coding uses this concept to skip runs of consecutive zero remaining bit planes values within a subband line. A run happens when (see FIG. 4 for an example):
The amount of consecutive coefficient groups 4001 to 4008 having zero remaining bitplanes equals a pre-defined, fixed number, also known as run length (see “Run #1” 4010 in FIG. 4 as an example).
Or the number of coefficient groups in the run is less than the run length, but the last coefficient is the last one in the subband and, as an optional further condition to be fulfilled, the rate required to signal the run is less than signaling the deltas remaining bit planes (see “Run #2” 4020 in FIG. 4 as an example). That is, choosing a run at the end of a subband can be optionally made by considering if that entails a save of bits.

Assumed that the encoding of the GCLI coefficients 4001 to 4008 is done sequentially (e.g. in FIG. 4, from left to right). When a run 4010, 4020 is encountered, only the first zero-valued GCLI 4001 of the run 4010 is signaled using the escape GCLI code. The rest of coefficient groups 4002 to 4008 within the run 4010 are then skipped.

### Zero-Tree Coding

Reference [8] proposes an intersubband alternative to efficiently compress zero GCLIs. Similarly to spatial zero-run coding (see preceding section above), an escape GCLI code is used to signal the absence of groups of GCLIs in the codestream.

GCLI zero-tree coding, as shown in FIG. 5, uses this concept to establish a zero tree 5000 in the wavelet domain, and to signal a GCLI value below the GTLI for a coefficient group, when the GCLI coefficient group itself and all its children GCLI coefficient groups are zero. Then the GCLIs of all the child coefficients can be omitted.

FIG. 5 shows an example of zero-tree coding. On top, zero-tree in a wavelet representation with two vertical and five horizontal decompositions. The considered precinct is marked by a bold border. At bottom, zero-tree corresponding to the figure on top. The numbers represent the subband ID to which the coefficient group belongs to. The left branch starting with square number ‘2’ identifies groups whose remaining bit planes shall be zero.

As explained above, FIG. 1 and FIG. 2 illustrate the output of a wavelet transform and how the wavelet coefficients are grouped to precincts, respectively. As can be seen, the precinct covers coefficients from different subbands.

Within the precinct, a zero-tree 5000 can be established. The root of this zero-tree is one coefficient group 5001 of the LL subband. For every other subband, the zero-tree contains a well-defined number of coefficient groups, whose number depend on the decomposition level of the subband. For the lowest decomposition level (Level 0), only one GCLI coefficient group is contained, while for higher subbands (e.g. Levels 1 to 9), more coefficient groups are contained. Let
dₛ^{h} be the horizontal decomposition level of subband s,
dₛ^{v} be the vertical decomposition level of subband s,
D^{h} be the number of horizontal decomposition levels
D^{v} be the number of vertical decomposition levels

Then the number of nodes from subband s equals 2^{D}^{^{v}}^{-d}^{ₛ}^{^{v}}·2^{D}^{^{h}}^{-d}^{ₛ}^{^{h}}. It is to be noted that the LL subband is defined to have D^{v}−dₛ^{v}= and D^{h}−dₛ^{h}=0.

Those coefficient groups are then brought into a parent-child relation as depicted in FIG. 5.

The LL coefficient 5001 forms the root of the tree 5000. Since the codec usually uses more horizontal than vertical decompositions, this root node 5001 only has one child node 5002. All further nodes have two children nodes, when only a horizontal decomposition is performed. For the first vertical and horizontal decomposition, the node 5004 has six children nodes. For all consecutive decompositions, a node 5005 has four children nodes belonging to the same subband.

Let's suppose now that the GCLI value of all shaded nodes 5010, 5011, 5012, 5013 in FIG. 5 equals zero. Then it is sufficient to signal an escape GCLI code for the shaded node 5011 of subband three. The GCLI of all the children nodes then need not to be transmitted in the bit stream anymore. The shaded node 5010 of subband two needs to be encoded as usual, since not all of its children have zero GCLI coefficient groups, see for example node 5004 and its children nodes.

It is noteworthy that, when working with image dimensions not power of two, the zero trees constructed in the boundaries can be incomplete (e.g. nodes in subband six can have only two children from subband 9, instead of four). In such cases, the zero trees are considered only when they incur a rate saving for signaling the tree, against signaling the delta remaining bits.

### Unary Coding

As mentioned before, the delta values 2060 calculated with the selected prediction mode (horizontal or vertical) may be transmitted using a variable length unary code, as described in Table 1 of [2].

FIG. 6 depicts an equivalent alphabet of said unary code defined in [2]. It is defined for values between −15 and 15 and sticks to lengths of up to 16 bits for efficient coding and decoding implementations. The alphabet contains prefix-free codes.

It can be seen that the unary code is composed of the following types of bits:
Data bits. They are conformed by “1”, and are directly related to the coded value. Here, the absolute value is given by the amount of “1”s. Note that for 0, the data bits is an empty set.
Stop bit. It is a “0”, and says when to stop reading the data bits. Note that for the boundaries (15 and −15), there is no need for a stop bit.
Sign bit. It can be a “1” or a “0”, depending if the value is negative or positive, respectively.

The state of the art unary code as shown in FIG. 6 is a simple symmetric unary code, wherein three bits are spent for coding the values ‘1’ and ‘−1’ respectively, due to the magnitude-sign-representation as mentioned above.

### Inventive Asymmetric Alphabets

In this invention, four alternative alphabets for the unary code in GCLI coding are proposed. They aim at improving coding efficiency by reducing the average required budget in GCLI coding. The forthcoming subsections give a description of these prefix-free alphabets.

Note that the descriptions are given for values from −15 to 15, and using at most 16 bits. However, they can be easily extended to higher (lower) values by going beyond 16 bits. This can be achieved by replacing those codes of length 16 by others that continue adding l's in the left.

Moreover, there are different scenarios in which these proposed alphabets can be used. On the one hand, they can be used as an option depending on the targeted bits per pixel (bpp), specifically for low bpp. On the other hand, the choice of whether to choose an alphabet for GCLI coding can be also made per precinct, or even per subband. This choice is done based on which alphabet requires the smaller budget to encode the precinct or subband.

In particular, this invention describes a set of asymmetric alphabets for the unary code of GCLI residuals. This method leads to increased compression efficiency. These alphabets can be categorized as follows:
Full-range alphabet: covers the whole range and sticks a desired maximum amount of bits.
Clipped alphabet: do not cover the whole range while it sticks to the desired maximum amount of bits.
Unsigned alphabet: unary codes are only for absolute values, while the sign bit is signaled separately.
Extended full-range alphabet: covers the whole range but does not stick to the desired maximum amount of bits.

These categories of alphabets will be described in detail in the following. Since these alphabets may be used for efficient coding, and in particular efficient GCLI coding, the inventive coders (i.e. encoder and decoder) shall be described first. The coders may be described for GCLI coding by way of example, wherein other coding schemes may also be used. Thus, reference will be made to FIG. 7 and FIG. 2 for describing the encoder, and to FIG. 8 and FIG. 2 for describing the decoder.

FIG. 7 shows an inventive encoder 70 for encoding a sequence of portions 71 of media into a data stream 72. The media may, for instance, be image data being coded into the data stream 72. The portions 71 of said media may, for instance, be one or more coefficient groups 2010, 2010′ as described above with reference to FIG. 2 if e.g. GCLI coding may be used. The sequence may be determined by some coding order defined between the portions 71, wherein the portions 71 may be subject to some sort of parallel coding despite the coding order.

The encoder 70 may be configured to derive a bit plane number predictor for a current portion 71. The encoder 70 may do so by, e.g. predictive coding. For example, if e.g. GCLI coding may be used, the bit plane number predictor may be a GCLI value 2030 of a previously coded coefficient group 2010, assumed that the coefficient group to be currently coded may be the second coefficient group 2010′ when taking FIG. 2 as an example.

The encoder 70 may further be configured to derive a bit plane number indicating coded bit-planes for the current portion 71. The encoder 70 may do so by, e.g. predictive coding. For example, if GCLI coding is used, a bit plane number may, for instance, be represented by a GCLI value 2030′ indicating the coded, i.e. active, bit planes.

The encoder 70 may further be configured to set a signed integer variable 73 so that the bit plane number 2030′ is derivable from a sum between the bit plane number predictor 2030 and the signed integer variable 73. Said signed integer variable 73 may represent in an encoded representation the delta remaining bit planes 2060, also referred to as δ-value, if e.g. GCLI coding is used.

The encoder 70 may further be configured to encode, for the current portion 71, the signed integer variable 73 into the data stream 72 by use of an inventive unary code, which will be described in detail below. Said unary code may be used at least for the values around zero.

A first example for an inventive unary code is shown in the table depicted in FIG. 9. The unary code comprises a series of codewords 91 of increasing length which are sequentially assigned to possible values of the signed integer variable 90.

The signed integer variable 90 may correspond to the integer valued variable 73 which has been previously described with reference to the inventive encoder 70 depicted in FIG. 7 and the inventive decoder 80 depicted in FIG. 8.

The codewords 91 are assigned to the possible values in a manner so that a first possible value 92 having a first sign and a predetermined absolute value (e.g. ‘+1’) has assigned a first codeword (e.g. ‘10’) of the unary code of a first length (e.g. two bit) which differs from a second length (e.g. three bit) of a second codeword of the unary code assigned to a second possible value 93a by exactly one, wherein the second possible value 93a has a second sign and the predetermined absolute value (e.g. ‘−1’).

Alternatively, the first possible value 92 having the first sign and the predetermined absolute value (e.g. ‘+1’) having assigned the first codeword (e.g. ‘10’) of the unary code of the first length (e.g. two bit) differs from a second length (e.g. one bit) of a second codeword of the unary code assigned to a second possible value 93b by exactly one, wherein the second possible value 93b is zero and the predetermined absolute value of the first value 92 is one.

In other words, the unary code codewords may be assigned in non-magnitude-plus-sign manner sequentially by traversing the possible values alternatingly 0→+/−→−/+1→4+/−2→−/+2 and so on.

Referring back to FIG. 7, the inventive encoder 70 may be configured to encode the current portion 71 into the data stream 72 by use of the bit plane number 2030′ being derivable from the sum between the bit plane number predictor 2030 and the signed integer variable 73, using the unary alphabet as described above.

The inventive encoder 70 may do so in that merely the relevant bits of the coefficients of the respective portion (group) are read from the bitstream or, alternatively speaking, the bit plane number may be used to determine the coded bit planes and the bits of coded bit planes may be read from the data stream (with setting the other bits to default values such as zero with respect to bits of more significant bit planes, and, optionally, zero or random values with respect to bits of lower significant bit planes).

The invention also concerns a decoder for decoding the above mentioned data stream. FIG. 8 shows an inventive decoder 80 for decoding a sequence of portions 71 (e.g. coefficient groups) of media from a data stream 72. The sequence may be determined by some coding order defined between the portions 71, wherein the portions 71 may be subject to some sort of parallel coding despite the coding order.

The decoder 80 may be configured to decode, for a current portion 71, a signed integer variable 73 from the data stream 72 by use of a unary code comprising a series of codewords of increasing length. As explained above with respect to the encoder 70, said signed integer variable may be a delta value indicating the delta remaining bit planes if, e.g. GCLI coding may be used. Furthermore, the unary code may be used at least for the values around zero.

One exemplary unary code shall again be described with reference to FIG. 9. As can be seen, the codewords 91 in this unary code are sequentially assigned to possible values of the signed integer variable 90 in a manner so that a first possible value 92 having a first sign and a predetermined absolute value (e.g. ‘+1’) has assigned a first codeword (e.g. ‘10’) of the unary code of a first length (e.g. two bits) which differs from a second length (e.g. three bits) of a second codeword (e.g. ‘110’) of the unary code assigned to a second possible value 93a by exactly one, wherein the second possible value 93a has a second sign and the predetermined absolute value (e.g. ‘−1’).

Alternatively, the first length (e.g. two bits) of the first codeword (e.g. ‘10’) of the unary code differs by exactly one from a second length (e.g. one bit) of a second codeword (e.g. ‘0’) of the unary code assigned to a second possible value 93b by exactly one, wherein the second possible value 93b is zero and the predetermined absolute value is one.

In other words, the unary code codewords may be assigned in non-magnitude-plus-sign manner sequentially by traversing the possible values alternatingly 0→+/−1→−/+1→+/−2→−/+2 and so on.

The inventive decoder 80 may further be configured to derive a bit plane number predictor for the current portion 71, and to derive a bit plane number (e.g. a GCLI value) indicating coded bit-planes by computing a sum of the bit plane number predictor and the signed integer variable.

Furthermore, the inventive decoder 80 may be configured to decode the current portion 71 from the data stream 72 by use of the bit plane number (e.g. GCLI value).

The inventive decoder 80 may do so in that merely the relevant bits of the coefficients of the respective portion (group) are read from the bitstream or, alternatively speaking, the bit plane number may be used to determine the coded bit planes and the bits of coded bit planes may be read from the data stream (with setting the other bits to default values such as zero with respect to bits of more significant bit planes, and, optionally, zero or random values with respect to bits of lower significant bit planes).

According to a further embodiment, the sequence of portions 71 of the media may be blocks of coefficients of a spectral decomposition of a picture, as described with reference to FIGS. 1 to 5 above.

According to yet a further embodiment, the spectral decomposition may be a wavelet transform or a block-wise spectral transform based on trigonometric basis functions.

According to yet a further embodiment, the portions 71 may be blocks of spatially neighboring coefficients within subbands into which the picture is decomposed by the spectral transform.

Referring back to FIG. 8, the inventive decoder 80 may be configured to derive a bit plane number predictor for the current portion 71. The decoder 80 may do so by, e.g. predictive coding.

Furthermore, the inventive decoder 80 may be configured to derive a bit plane number (e.g. a GCLI value) indicating coded bit-planes by computing a sum of the bit plane number predictor (e.g. GCLI value of previously decoded coefficient group) and the signed integer variable, i.e. the above mentioned delta value 90.

Furthermore, the inventive decoder 80 may be configured to decode the current portion 71 from the data stream 72 by use of the bit plane number (e.g. GCLI value).

In the following, several examples of alphabets comprising unary codes that may be used by the inventive coders 70, 80 in the above described manner shall be introduced and discussed below.

### A) Full-Range Alphabets for Unary Coding (e.g. of GCLI Values)

A first set of alphabets comprising unary codes will be exemplarily described below with reference to the following four different types of full-range alphabets for unary coding of GCLI values.

### A1) Full-Range Alphabet #1 for Unary Coding

FIG. 9 shows the first full-range alphabet. As already described above, the alphabet comprises a unary code. This unary code may comprise at least the values ‘0’, ‘+1’ and ‘−1’. The unary code may be an asymmetric unary code. That is, ‘0’ is coded with one bit, ‘+1’ is coded with two bits and ‘−1’ is coded with three bits. Remember, the unary codes of the state of the art, as shown in FIG. 6 were symmetric unary codes, i.e. ‘0’ was coded with one bit, while both ‘+1’ and ‘−1’ are coded with three bits.

The aim of the alphabet shown in FIG. 9 is to save one bit to code the value ‘+1’ with respect to the state of the art (FIG. 6), since this value occurs frequently in a typical bit stream.

### A2) Full-Range Alphabet #2 for Unary Coding

FIG. 10 shows a second full-range alphabet. The second full-range alphabet corresponds to the first full-range alphabet with the difference of unary coding the values ‘+1’ and ‘−1’. The coding of these two values is switched compared to the first alphabet. In particular, the value ‘+1’ is coded with three bits while the value ‘−1’ is coded with two bits.

The aim of this second alphabet shown in FIG. 10 is to save one bit to code the value ‘−1’ with respect to the state of the art (FIG. 6), since this value occurs frequently in a typical bit stream.

### A3) Full-Range Alphabet #3 for Unary Coding

FIG. 11 shows a third full-range alphabet. It comprises the unary code as described above, wherein in this case said unary code comprises at least the values ‘0’, ‘+1’, ‘−1’, ‘+2’ and ‘−2’. The unary code is an asymmetric code, wherein the value ‘0’ is coded using one bit, the value ‘+1’ is coded using two bits, the value ‘−1’ is coded using three bits, the value ‘+2’ is coded using four bits and the value ‘−2’ is coded using five bits.

The aim of this third alphabet is to save one bit to code the value ‘+1’ with respect to the state of the art (FIG. 6), and also one bit to code the value ‘+2’ with respect to the first full-range alphabet #1 (FIG. 9).

### A4) Full-Range Alphabet #4 for Unary Coding

FIG. 12 shows a fourth full-range alphabet. The fourth full-range alphabet corresponds to the third full-range alphabet with the difference of unary coding the values ‘+1’, ‘−1’, ‘+2’ and ‘−2’. The coding of these values is switched compared to the third alphabet. In particular, the value ‘0’ is coded using one bit, the value ‘−1’ is coded using two bits, the value ‘+1’ is coded using three bits, the value ‘−2’ is coded using four bits and the value ‘+2’ is coded using five bits.

The aim of this alphabet is to save one bit to code the value ‘−1’ with respect to the state of the art (FIG. 6), and also one bit to code the value ‘−2’ with respect to the second full-range alphabet #2.

### B) Clipped Signal Alphabets for Unary Coding (e.g. of GCLI Values)

Similarly to the alphabets defined in previous Section A), which are defined for a whole range of values for GCLIs between −15 to 15, it is also possible to define alphabets with a clipped (smaller) range. The clipped variants of each alphabet defined above are depicted in FIGS. 13 to 16.

However, clipped alphabets may work as an option to be chosen per precinct or per subband, being as an alternative the alphabet defined in the state of the art (FIG. 6) or any of the here-introduced full-range alphabets. Indeed, as long as a value to be coded is out of range, the clipped alphabet may therefore be forbidden and instead the alternative alphabet shall be selected.

Moreover, since the choice is made per precinct/subband, there is no need to implement a global switch depending on the targeted bpp.

Such clipped alphabtes, thus, enable a compression gain in case of being offered in addition to a full-range alphabet as a fallback alphabet. Another advantage of a clipped alphabet is that it doesn't require an special set of codewords to complete the range, what is hard for parallel decoders.

### B1) Clipped Signed Alphabet #1 for Unary Coding

FIG. 13 shows a first clipped signed alphabet for unary coding of, for instance, GCLI values. The alphabet comprises an inventive unary code at least for the values around zero, and in particular for at least the values ‘0’, ‘+1’ and ‘−1’ as an example.

The unary code may be an asymmetric unary code. That is, ‘0’ is coded with one bit, ‘+1’ is coded with two bits and ‘−1’ is coded with three bits. Remember, the unary codes of the state of the art, as shown in FIG. 6 were symmetric unary codes, wherein ‘0’ is coded with one bit, while both ‘+1’ and ‘−1’ are coded with three bits.

Furthermore, the values ‘+15’ and ‘−15’ are clipped.

The aim of this first clipped signed alphabet #1 is to save one bit to code the value 1 with respect to the state of the art (FIG. 6), since this value occurs frequently in a typical bit stream.

### B2) Clipped Alphabet #2 for Unary Coding

FIG. 14 shows a second clipped signed alphabet for unary coding of, for instance, GCLI values. The alphabet comprises an inventive unary code at least for the values around zero, and in particular for at least the values ‘0’, ‘+1’ and ‘−1’ as an example.

This unary code may be an asymmetric unary code. That is, ‘0’ is coded with one bit, ‘−1’ is coded with two bits and ‘+1’ is coded with three bits. Furthermore, the values ‘+15’ and ‘−15’ are clipped.

The aim of this second clipped alphabet #2 is to save one bit to code the value ‘−1’ with respect to the state of the art (FIG. 6).

### B3) Clipped Alphabet #3 for Unary Coding

FIG. 15 shows a third clipped signed alphabet for unary coding of, for instance, GCLI values. The alphabet comprises an inventive unary code at least for the values around zero, and in particular for at least the values ‘0’, ‘+1’, ‘−1’, ‘+2’ and ‘−2’ as an example.

This unary code may be an asymmetric unary code. That is, ‘0’ is coded with one bit, ‘+1’ is coded with two bits, ‘−1’ is coded with three bits, ‘+2’ is coded with four bits and ‘−2’ is coded with five bits. Furthermore, the values ‘+14’, ‘−14’, ‘+15’ and ‘−15’ are clipped.

The aim of this third clipped alphabet #3 is to save one bit to code the value ‘+’1 with respect to the state of the art (FIG. 6), and also one bit to code the value ‘+2’ with respect to the first clipped alphabet #1.

### B4) Clipped Alphabet #4 for Unary Coding

FIG. 16 shows a fourth clipped signed alphabet for unary coding of, for instance, GCLI values. The alphabet comprises an inventive unary code at least for the values around zero, and in particular for at least the values ‘0’, ‘+1’, ‘−1’, ‘+2’ and ‘−2’ as an example.

This unary code may be an asymmetric unary code. That is, ‘0’ is coded with one bit, ‘−1’ is coded with two bits, ‘+1’ is coded with three bits, ‘−2’ is coded with four bits and ‘+2’ is coded with five bits. Furthermore, the values ‘+14’, ‘−14’, ‘+15’ and ‘−15’ are clipped.

The aim of this fourth clipped alphabet #4 is to save one bit to code the value ‘−1’ with respect to the state of the art (FIG. 6), and also one bit to code the value ‘−2’ with respect to the second clipped alphabet #2.

### C) Unsigned Alphabets for Unary Coding (e.g. of GCLI Values)

Similarly to the alphabets defined in previous Section A), which are defined for a whole range of values for GCLIs between −15 to 15, it is also possible to define alphabets with a clipped (smaller) range, as shown in Section B).

However, in some scenarios, the sign bits corresponding to the unary codes are signaled separately in the code stream. Hence, the unary code for the clipped alphabet can harness this situation in order to expand the range of supported values.

In this way, the alphabets #1 (c.f. FIG. 17) and #2 (c.f. FIG. 18) as they will be discussed in the following in this section C) become full range, since they are now able to cover the values 15 and −15. However, the unsigned alphabets #3 (c.f. FIG. 19) and #4 (c.f. FIG. 20) as they will be discussed in the following in this section C) are clipped.

Therefore, similarly to the clipped alphabets introduced in Section B), the clipped unsigned alphabets #3 (c.f. FIG. 19) and #4 (c.f. FIG. 20) may work as an option to be chosen per precinct or per subband, being as an alternative to the alphabet defined in the state of the art (FIG. 6) or any of the here-introduced full-range alphabets. Indeed, as long as a value to be coded is out of range, the clipped alphabet may therefore be forbidden and instead the alternative alphabet shall be selected.

### C1) Full-Range Unsigned Alphabet #1 for Unary Coding (e.g. of GCLI Values)

FIG. 17 shows a first full-range unsigned alphabet for unary coding of, for instance, GCLI values. The alphabet comprises an inventive unary code at least for the values around zero, and in particular for at least the values ‘0’, ‘+1’ and ‘−1’ as an example.

The unary code may be an asymmetric unary code. That is, ‘0’ is coded with one bit, ‘+1’ is coded with two bits and ‘−1’ is coded with three bits. Remember, the unary codes of the state of the art, as shown in FIG. 6 were symmetric unary codes, wherein ‘0’ is coded with one bit, while both ‘+1’ and ‘−1’ are coded with three bits.

The aim of this first unsigned full-range alphabet is to save one bit to code the value ‘+1’ with respect to the state of the art (FIG. 6), since this value occurs frequently in a typical bit stream.

The sign bit must be signaled separately at least for the values such that ‘value’>1.

### C2) Full-Range Unsigned Alphabet #2 for Unary Coding (e.g. of GCLI Values)

FIG. 18 shows a second full-range unsigned alphabet for unary coding of, for instance, GCLI values. The alphabet comprises an inventive unary code at least for the values around zero, and in particular for at least the values ‘0’, ‘+1’ and ‘−1’ as an example.

The unary code may be an asymmetric unary code. That is, ‘0’ is coded with one bit, ‘−1’ is coded with two bits and ‘+1’ is coded with three bits. Remember, the unary codes of the state of the art, as shown in FIG. 6 were symmetric unary codes, wherein ‘0’ is coded with one bit, while both ‘+1’ and ‘−1’ are coded with three bits.

The aim of this second unsigned full-range alphabet is to save one bit to code the value ‘−1’ with respect to the state of the art (FIG. 6).

The sign bit must be signaled separately at least for the values such that ‘value’>1.

### C3) Clipped Unsigned Alphabet #3 for Unary Coding (e.g. of GCLI Values)

FIG. 19 shows a third alphabet, namely a clipped unsigned alphabet for unary coding of, for instance, GCLI values. The alphabet comprises an inventive unary code at least for the values around zero, and in particular for at least the values ‘0’, ‘+1’, ‘−1’, ‘+2’ and ‘−2’ as an example.

The unary code may be an asymmetric unary code. That is, ‘0’ is coded with one bit, ‘+1’ is coded with two bits, ‘−1’ is coded with three bits, ‘+2’ is coded with four bits and ‘−2’ is coded with five bits. Remember, the unary codes of the state of the art, as shown in FIG. 6 were symmetric unary codes, wherein ‘0’ is coded with one bit, while both ‘+1’ and ‘−1’ are coded with three bits.

Furthermore, the values ‘+15’ and ‘−15’ are clipped.

The aim of this third alphabet is to save one bit to code the value ‘+1’ with respect to the state of the art (FIG. 6), and also one bit to code the value ‘+2’ with respect to the first alphabet #1 of this section C).

The sign bit must be signaled separately at least for the values such that ‘value’>2.

### C4) Clipped Unsigned Alphabet #4 for Unary Coding (e.g. of GCLI Values)

FIG. 20 shows a fourth alphabet, namely a clipped unsigned alphabet for unary coding of, for instance, GCLI values. The alphabet comprises an inventive unary code at least for the values around zero, and in particular for at least the values ‘0’, ‘+1’, ‘−1’, ‘+2’ and ‘−2’ as an example.

The unary code may be an asymmetric unary code. That is, ‘0’ is coded with one bit, ‘−1’ is coded with two bits, ‘+1’ is coded with three bits, ‘−2’ is coded with four bits and ‘+2’ is coded with five bits. Remember, the unary codes of the state of the art, as shown in FIG. 6 were symmetric unary codes, wherein ‘0’ is coded with one bit, while both ‘+1’ and ‘−1’ are coded with three bits.

Furthermore, the values ‘+15’ and ‘−15’ are clipped.

The aim of this fourth alphabet is to save one bit to code the value ‘−1’ with respect to the state of the art (FIG. 6), and also one bit to code the value ‘−2’ with respect to the second alphabet #2 of this section C).

The sign bit must be signaled separately at least for the values such that ‘value’>2.

### D) Extended Full-Range Alphabets for Unary Coding (e.g. of GCLI Values)

Similarly to the alphabets defined in previous Section C), which are defined for a whole range of values for GCLIs between −15 to 15, and employing at maximum 16 bits for a unary code, it is also possible to define alphabets with an extended amount of bits for the same range.

The extended variants of each alphabet defined above are depicted in FIGS. 21 to 24.

As with the full-range alphabets defined in section A) above, these extended alphabets of this section D) can be employed as alternatives to the state of the art (FIG. 6), either per precinct and/or subband, or globally to the complete image.

It can be also considered as a choice depending on the targeted bpp, by the same means explained before.

Boundaries can end in different ways, now that the number of bits is not a restriction. In FIG. 21, FIG. 22, FIG. 23 and FIG. 24, the values for −15 and 15 may be without a stop “0” bit, but they can have a value using a stop “0” bit likewise the value for −14 and 14 (respectively), just by adding a “1” at the left.

Alphabets with such an enforced stop bit at boundaries are easier to decode, in general, and can be easily extended to larger ranges beyond 15/−15. Moreover, the state of the art alphabet shown in FIG. 6 can be also extended in this way.

### D1) Extended Full-Range Alphabet #1 for Unary Coding (e.g. of GCLI Values)

FIG. 21 shows a first extended full-range alphabet for unary coding of e.g. GCLI values. The alphabet comprises an inventive unary code at least for the values around zero, and in particular for at least the values ‘0’, ‘+1’ and ‘−1’ as an example.

The unary code may be an asymmetric unary code. That is, ‘0’ is coded with one bit, ‘+1’ is coded with two bits and ‘−1’ is coded with three bits. Remember, the unary codes of the state of the art, as shown in FIG. 6 were symmetric unary codes, wherein ‘0’ is coded with one bit, while both ‘+1’ and ‘−1’ are coded with three bits.

Furthermore, compared with the regular (i.e. non-extended) full range alphabet #1 in section A), the extended full-range alphabet #1 of FIG. 21 spends 15 bits for coding the values ‘+12’ and ‘−12’ and 17 bits for coding the values ‘+14’, ‘−14’, ‘+15’ and ‘−15’.

The aim of this first extended full-range alphabet #1 is to save one bit to code the value ‘+1’ with respect to the state of the art (FIG. 6), since this value occurs frequently in a typical bit stream.

### D2) Extended Full-Range Alphabet #2 for Unary Coding (e.g. of GCLI Values)

FIG. 22 shows a second extended full-range alphabet for unary coding of e.g. GCLI values. The alphabet comprises an inventive unary code at least for the values around zero, and in particular for at least the values ‘0’, ‘+1’ and ‘−1’ as an example.

The unary code may be an asymmetric unary code. That is, ‘0’ is coded with one bit, ‘−1’ is coded with two bits and ‘+1’ is coded with three bits. Remember, the unary codes of the state of the art, as shown in FIG. 6 were symmetric unary codes, wherein ‘0’ is coded with one bit, while both ‘+1’ and ‘−1’ are coded with three bits.

Furthermore, compared with the regular (i.e. non-extended) full range alphabet #2 in section A), the extended full-range alphabet #2 of FIG. 22 spends 15 bits for coding the values ‘+12’ and ‘−12’ and 17 bits for coding the values ‘+14’, ‘−14’, ‘+15’ and ‘−15’.

The aim of this second extended full-range alphabet #2 is to save one bit to code the value ‘-1’ with respect to the state of the art (FIG. 6), since this value occurs frequently in a typical bit stream.

### D3) Extended Full-Range Alphabet #3 for Unary Coding (e.g. of GCLI Values)

FIG. 23 shows a third extended full-range alphabet for unary coding of e.g. GCLI values. The alphabet comprises an inventive unary code at least for the values around zero, and in particular for at least the values ‘0’, ‘+1’, ‘−1’, ‘+2’ and ‘−2’ as an example.

The unary code may be an asymmetric unary code. That is, ‘0’ is coded with one bit, ‘+1’ is coded with two bits, ‘−1’ is coded with three bits, ‘+2’ is coded with four bits and ‘−2’ is coded with five bits. Remember, the unary codes of the state of the art, as shown in FIG. 6 were symmetric unary codes, wherein ‘0’ is coded with one bit, while both ‘+1’ and ‘−1’ are coded with three bits.

The aim of this third extended full-range alphabet #3 is to save one bit to code the value ‘+1’ with respect to the state of the art (FIG. 6), and also one bit to code the value ‘+2’ with respect to the first extended full-range alphabet #1 in this section.

### D4) Extended Full-Range Alphabet #4 for Unary Coding (e.g. of GCLI Values)

FIG. 24 shows a fourth extended full-range alphabet for unary coding of e.g. GCLI values. The alphabet comprises an inventive unary code at least for the values around zero, and in particular for at least the values ‘0’, ‘+1’, ‘−1’, ‘+2’ and ‘−2’ as an example.

The unary code may be an asymmetric unary code. That is, ‘0’ is coded with one bit, ‘−1’ is coded with two bits, ‘+1’ is coded with three bits, ‘−2’ is coded with four bits and ‘+2’ is coded with five bits. Remember, the unary codes of the state of the art, as shown in FIG. 6 were symmetric unary codes, wherein ‘0’ is coded with one bit, while both ‘+1’ and ‘−1’ are coded with three bits.

The aim of this fourth extended full-range alphabet #4 is to save one bit to code the value ‘−1’ with respect to the state of the art (FIG. 6), and also one bit to code the value ‘−2’ with respect to the second extended full-range alphabet #2 in this section.

Alphabets for Unary Coding (e.g. of GCLI Values) with Different Ranges or Different Length Restrictions

The introduced alphabets above (full-range, clipped (signed and unsigned) and extended full-range alphabets #1, #2, #3 and #4) are defined for a range of values for GCLIs between −15 and 15 and a maximum of 16 bits as a target. Note that the same principles can be applied to the alphabets when:
Increasing or decreasing the range of values, e.g. −31 to 31 (or any other values).
Increasing or decreasing the maximum amount of bits, e.g. 32 bits (or any other number of bits).

### Benefit of the Proposed Alphabet for Spatial Zero-Run and Zero-Tree Coding

The usage of alphabets where negative values require less bits than positive values (FIG. 10, FIG. 12, FIG. 14, FIG. 16, FIG. 18, FIG. 20, FIG. 22 and FIG. 24) will increase the frequency in which zero-run and zero-tree coding modes are selected, since the bits to signal the escape GCLI code is lower. Moreover, the zero-run is encoded more efficiently.

Specifically in subband boundaries, zero-runs and also zero-trees (when image dimensions are not power of 2) have a more relaxed condition for usage so that smaller groups can be also considered for the runs. To this end, FIG. 25 depicts the number of additional bits required for emitting an escape GCLI code instead of the unary code required when not using a zero-run or zero-tree coding method.

Depending on the alphabet and the prediction reference, it varies between zero and three bits. However, by selecting the appropriate alphabet, the number of additional bits can be minimized for those prediction reference values that are occurring more frequently.

Moreover, obviously an escape GCLI code should only be emitted when the savings from the omitted coefficients exceeds the number of additional bits required for the escape GCLI.

Thus, a lower number of additional bits for reference values with higher probability of occurrence allow more frequent use of zero runs with smaller size. Such small-sized zero runs occur at subband boundaries as described in the section above called “spatial zero-run coding”.

Similar reason is valid for a zero-tree, when the number of children nodes is smaller than usual as explained in the section above called “zero-tree coding” for image dimensions not being powers of two. Then, by making the number of additional bits for an escape GCLI code as small as one for the frequently occurring prediction reference values, usage of a zero-tree either improves coding efficiency or does not change it. But, it cannot get worse for these frequently occurring reference values.

### FURTHER EMBODIMENTS

Now that examples of alphabets with unary codes have been introduced, which alphabets may be used for coding by the inventive coders 70, 80, further embodiments of the coders 70, 80 will be described in the following.

The embodiments will be exemplarily described for the decoder 80. However, everything that will be described with respect to the decoder 80 also holds true for the inventive encoder 70, except where explicitly stated otherwise. Furthermore, whenever the term coding may be used, this term may refer to both encoding and decoding.

According to an embodiment, the inventive coders 70, 80 may be configured to code the signed integer variable 90 from/into the data stream 72 by use of one of the above described unary codes if the integer valued variable 90 falls within a first subinterval 94 of a value range of the signed integer variable 90. As exemplarily described with reference to the unary code depicted in FIG. 9 the first subinterval 94 may be the interval between values ‘−1’ and ‘+1’.

Furthermore, the inventive coders 70, 80 of this embodiment may be configured to code the signed integer variable 90, if the signed integer variable 90 falls within a second subinterval 95 of the value range of the signed integer variable 90, from the data stream by coding magnitude and sign of the signed integer variable 90 separately, wherein the magnitude is coded by use of a further unary code, and separately coding a sign bit, wherein none of the further unary code's codewords used in the second interval 95 is a prefix of any codeword of the unary code used in the first interval 94, and vice versa.

As can be seen, the first interval 94 may comprise an asymmetric unary code (as described in sections A to D above) while the second interval 95 may comprise a symmetric unary code.

According to yet a further embodiment, the inventive coders 70, 80 may be configured to code the magnitude and sign of the signed integer variable 90 from/into contiguous bits of the data stream 72 or to code the magnitude and sign of the signed integer variable 90 from/into different fragments of the data stream 72 a first one of which is related to the magnitude, and a second one of which is related to the sign.

In other words, the magnitude bits may be coded from/into a first data stream, while the sign bit(s) may be coded from/into a second data stream. That is, the sign may be either coded in the codeword or coded separately.

Referring back to FIG. 9, the first subinterval 94 is contiguous and comprises the value ‘0’ (zero). Contiguous means that the values contained in said subinterval 94 (e.g. the values ‘+1’, ‘0’, ‘−1’) directly follow one another without any values of any further intervals therebetween. Furthermore, the second subinterval 95 flanks the first subinterval 94 on both sides (i.e. positive and negative value sides) of the first subinterval 94. With reference to the example shown in FIG. 9, the second subinterval 95 extends in the positive direction from values ‘+2’ to ‘+11’ and, in the opposite negative direction from values ‘−2’ to ‘-11’ with the values ‘+1’, ‘0’ and ‘−1’ of the first subinterval 94 in between.

According to yet another embodiment, the inventive coders 70, 80 may be configured to code the signed integer variable 90, if the signed integer variable 90 falls within a third subinterval 96 of the value range of the signed integer variable 90, from/into the data stream by decoding magnitude and sign of the signed integer variable 90 separately, wherein the magnitude is coded by use of a fixed length code prefixed with a codeword of which neither one of the codewords of the unary code 94 and the further unary code 95 is a prefix, followed by decoding a sign bit, wherein the first subinterval 94 is contiguous and comprises zero, the second subinterval 95 flanks the first subinterval 94 on both sides of the first subinterval 94, and the third subinterval 96 flanks the second subinterval 95 on both outer sides of the second subinterval 95.

In the example shown in FIG. 9, a first unary code is exploited to code the values within the first subinterval 94, a second unary code is exploited to code the values within the second subinterval 95 and a fixed-length code (e.g. two bits, i.e. third and second last ones in FIG. 9—prefixed with a codeword) is exploited to code the values within the third subinterval 96, wherein the first unary code is an asymmetric code and the second unary code is a symmetric code.

Of course, the variable length code (VLC) alphabet of FIG. 9 was only described as an example. All of the above described other alphabets may be exploited in the same way.

According to embodiments, the vlc alphabets may differ in cardinality of a set of possible values of the signed integer variable 90 and/or in maximum codeword length. The cardinality is the number of elements. For example, the unary code shown in FIG. 9 ranges from ‘+15’ to ‘−15’, while the unary code shown in FIG. 16 ranges from ‘+13’ to ‘−13’. Furthermore, the maximum codeword length of the unary code shown in FIG. 20 ranges up to 16 bits, while the maximum codeword length of the unary code shown in FIG. 21 ranges up to 17 bits.

According to embodiments, the inventive decoder 80 may be configured to derive from the data stream 72 for each of different sections of the spectral decomposition a hint as to which of a set of variable length code (VLC) alphabets to use for the decoding the signed integer variable 90 of portions within the respective section, with at least one of the VLC alphabets involving the unary code.

According to corresponding embodiments, the inventive encoder 70 may be configured to provide in the data stream 72 for each of different sections of the spectral decomposition a hint which of a set of variable length code (VLC) alphabets is used for encoding the signed integer variable 90 of portions within the respective section, wherein at least one of the VLC alphabets involves the unary code.

According to embodiments, the above mentioned different sections may correspond to different subbands into which the picture is subdivided by the spectral decomposition, as explained further above.

In other words, the inventive coders 70, 80 may be configured to switch between alphabets in order to limit a maximum codeword length, e.g. compare FIG. 9 and FIG. 16. An alphabet may be switched in order to achieve the best possible quality, e.g. switching between the alphabet shown in FIG. 9 and the alphabet shown in FIG. 6, for instance.

According to yet further embodiments, the unary code may define a subset of a VLC alphabet used for coding the signed integer variable 90 from/into the data stream 72, wherein all VLC alphabet's codewords other than the codewords of the unary code may comprise a concatenation of a unary codeword ending with zero, followed by a sign bit. This may correspond to an enforcement of a stop-bit for easier decoding.

As described above, spatial prediction may be used for coding GCLI residuals. Thus, according to embodiments, the inventive coders 70, 80 may be configured to derive the bit plane number predictor for the current portion 71 by using spatial prediction.

According to embodiments, the inventive coders 70, 80 may be configured to initiate a so-called escape coding mechanism with respect to subsequent portions (i.e. consecutive with respect to the coding order) of the media depending on the signed integer value 90.

An example of an escape coding mechanism may be a zero run coding, wherein coefficients of predetermined portions (e.g. coefficient groups) are set to zero (or some noise is synthesized therein) and coding a signed integer variable 90 is skipped for such portions.

For performing escape encoding, the inventive encoder 70 may comprise a determination unit 74 (c.f. FIG. 7) that is configured to determine whether to exploit escape coding. After determination the integer valued variable 73, 90 may be escape-encoded in the encoding unit 75. Since the escape coding mechanism is optional in this invention, i.e. all of the herein described alphabets may also be used when not foreseeing any run method, both the determination unit 74 and the encoding unit 75 are optional.

For performing escape decoding, the inventive decoder 80 may comprise a decoding unit 84 (c.f. FIG. 8) that is configured to decode the integer variable 73, 90 which, in this case, indicates a run of coefficients. After decoding the integer valued variable 73, 90 the portions of media may be reconstructed in a reconstruction unit 85. Since the escape coding mechanism is optional in this invention, i.e. all of the herein described alphabets may also be used when not foreseeing any run method, both the decoding unit 84 and the reconstruction unit 85 are optional.

According to embodiments, the inventive coders 70, 80 may be configured to initiate the escape coding mechanism with respect to subsequent portions of the media if the bit plane number derived is negative, and the series of codewords of increasing length are sequentially assigned to a set of possible values {0, . . . ,±a} of the signed integer variable 90 such that the codewords' length assigned to the set increases from possible value 0 to possible value ‘a’ according to 0, −1, 1, . . . , −a, +a with ‘a’ being an integer number greater than 0.

In other words, shorter codewords may be used for spatial zero-run coding.

According to yet further such embodiments, the inventive coders 70, 80 may be configured to skip coding the signed integer variable 90 from/into the data stream 72 for those portions for which the escape coding mechanism is initiated.

According to yet further such embodiments, the inventive coders 70, 80 may be configured to, in coding the current portion 71 from/into the data stream 72 by use of the bit plane number, code bits of bit planes with respect to the current portion from/into the data stream 72, which are indicated by the bit plane number, and skip coding the bits of the bit planes from/into the data stream 72 for those portions for which the escape coding mechanism is initiated.

Generally, the prediction may be performed as a horizontal prediction or as a vertical prediction.

According to embodiments, the inventive coders 70, 80 may be configured to derive the bit plane number predictor for the current portion using spatial prediction along a prediction direction coinciding with a coding order along which the sequence of portions are ordered. Thus, this corresponds to a horizontal prediction.

According to a further such embodiment, the coding order traverses the portions row by row.

According to further embodiments, the inventive coders 70, 80 may, additionally or alternatively, be configured to derive the bit plane number predictor for the current portion 71 by using spatial prediction along a prediction direction, wherein the prediction direction is a column direction and a coding order along which the sequence of portions are ordered traverses the portions row by row. This corresponds to a vertical prediction.

The inventive coders 70, 80 may also be configured to use both the horizontal and the vertical predictions selectively. That is, the coders 70, 80 may be configured to selectively choose which one of the horizontal and the vertical prediction may be best suited for coding the current portions.

According to such embodiments, the inventive coders 70, 80 may be configured to derive the bit plane number predictor for the portions using spatial prediction along a first prediction direction (horizontal) coinciding with a coding order along which the sequence of portions are ordered or along a second prediction direction (vertical), wherein the second prediction direction is a column direction and the coding order traverses the portions row by row, wherein the coder 70, 80 decides, on a subband by subband basis, depending on the data stream 72, to use the first prediction direction or the second prediction direction for portions within the subbands.

According to yet further embodiments, the inventive coders 70, 80 may be configured to restrict the initiating the escape coding mechanism with respect to subsequent portions of the media depending on the signed integer value 90 to a proper subset of the portions.

In other words, the signed integer value 90 may represent a so-called escape GCLI code indicating towards the coders 70, 80 to use the escape coding mechanism, e.g. to skip coding of certain subsequent portions of the media (i.e. a predetermined number of subsequent coefficient groups) from/into the data stream 72. Said proper subset of portions of media may, for instance be, a predetermined number of subsequent coefficient groups that have no active bit planes.

According to yet further embodiments, the inventive coders 70, 80 may be configured so that said proper subset of the portions is distanced along a coding order along which the sequence of portions are ordered, by a predetermined number of portions coinciding, in number, with the subsequent portions with respect to which the escape coding mechanism is initiated. In other words, the coders 70, 80 may use the escape coding mechanism for coefficient groups of a predetermined run-length. That is, if a number of consecutive coefficient groups having no active bit planes is equal or larger than the predetermined run-length, then these coefficient groups are part of a run of the predetermined run-length, and coding of these coefficient groups may be skipped. A run may start at a selected one coefficient group which may also be referred to as a run head.

According to yet further embodiments, the inventive coder 70, 80 may be configured to derive the bit plane number predictor for the current portion using spatial prediction along a prediction direction (e.g. vertical prediction direction), wherein the prediction direction is a column direction and a coding order along which the sequence of portions are ordered traverses the portions row by row, and wherein the proper subsets of the portions form mutually vertically aligned portions, wherein the coders 70, 80 may be configured to perform the coding of the signed integer variable 90, deriving the bit plane number predictor and deriving the bit plane number with respect to the proper subset of portions at a first fragment of the data stream which precedes a second fragment of the data stream at which the coder performs the above mentioned actions of decoding and deriving, in particular for portions external to and subsequent (in terms of the coding order) to said proper subset of portions.

In other words, the GCLIs of run heads are arranged first in the data stream, followed by GCLIs of non-run heads. This is exemplarily depicted in FIG. 26 which shows an exemplary data stream 72. As can be seen, the GCLIs 261 of the run heads are arranged before the GCLIs 262 of other non-run head coefficient groups.

According to yet further embodiments, the inventive coders 70, 80 may be configured to perform the coding of the signed integer variable 90, deriving the bit plane number predictor and deriving the bit plane number with respect to the sequence of portions at a bit plane number indication fragment 262 of the data stream 72 which precedes a bit plane indication fragment 263 of the data stream 72 at which the coder 70, 80 performs the coding of the portions of media.

In other words, the GCLIs of the coefficient groups are arranged first in the data stream 72, followed by data contained in the bit planes of the respective coefficient groups. This is exemplarily depicted in FIG. 26 which shows that the GCLIs 262 of the coefficient groups are arranged within the data stream 72 before the data 263 of the respective coefficient groups.

Further embodiments of the invention concern a method for encoding and a method for decoding a sequence of portions of media into/from a data stream.

FIG. 27 shows an embodiment of a method for decoding a sequence of portions of media from a data stream according to an embodiment.

In block 271a it is decoded, for a current portion, a signed integer variable from the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs by exactly one from a second length of a second codeword of the unary code assigned to a second possible value having a second sign and the predetermined absolute value.

Alternatively, in block 271b, it is decoded, for a current portion, a signed integer variable from the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs by exactly one from a second length of a second codeword of the unary code assigned to a second possible value being zero with the predetermined absolute value being one.

In block 272, a bit plane number predictor for the current portion is derived.

In block 273, a bit plane number is derived, the bit plane number indicating coded bit-planes by computing a sum of the bit plane number predictor and the signed integer variable.

In block 274, the current portion is decoded from the data stream by use of the bit plane number.

FIG. 28 shows an embodiment of a method for encoding a sequence of portions of media into a data stream according to an embodiment.

In block 281, a bit plane number predictor for a current portion is derived.

In block 282, a bit plane number is derived, the bit plane number indicating coded bit-planes for the current portion and setting a signed integer variable so that the bit plane number is derivable from a sum between the bit plane number predictor and the signed integer variable.

In block 283a it is encoded, for the current portion, the signed integer variable into the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs by exactly one from a second length of a second codeword of the unary code assigned to a second possible value having a second sign and the predetermined absolute value.

In block 283b, alternatively, it is encoded, for the current portion, the signed integer variable into the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs by exactly one from a second length of a second codeword of the unary code assigned to a second possible value being zero with the predetermined absolute value being one.

In block 284, the current portion is encoded into the data stream by use of the bit plane number.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

The above described embodiments are merely illustrative for the principles of the present invention. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

For further background knowledge, in particular with respect to the above mentioned escape coding mechanism, the entire content including the description, the claims, the figures and the abstract of European Patent Application No. 17162866.2 is incorporated herein by reference.

### REFERENCES

[1] AMBROISE RENAUD; BUYSSCHAERT CHARLES; PELLEGRIN PASCAL; ROUVROY GAEL, “Method and Device for Display Stream Compression”, U.S. Pat. No. 9,332,258 BB
[2] AMBROISE RENAUD; BUYSSCHAERT CHARLES; PELLEGRIN PASCAL; ROUVROY GAEL, “Method and Device for display stream compression”, EP2773122 A1
[3] Jean-Baptiste Lorent, “TICO Lightweight Codec Used in IP Networked or in SDI Infrastructure”, SMPTE RDD 35:2016
[4] Toshiaki Kojima, “LLVC—Low Latency Video Codec for Network Transfer”, SMPTE RDD 34:2015
[5] J. Kim and C. M. Kyung, “A Lossless Embedded Compression Using Significant Bit Truncation for HD Video Coding”, IEEE Transactions on Circuits and Systems for Video Technology, 2010
[6] intoPIX, “intoPIX Codec Submission for JPEG-XS CfP”, Design Description v0.1, 2016
[7] EP16194250, “Intra subband run-coding for low complexity image and video coding”
[8] EP 16194938.3 “Zero tree coding for low complexity image and video coding”

1. A decoder for decoding a sequence of portions of media from a data stream by:
decoding, for a current portion, a signed integer variable from the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs from a second length of a second codeword of the unary code assigned to a second possible value
having a second sign and the predetermined absolute value, or
being zero with the predetermined absolute value being one,
by exactly one;
deriving a bit plane number predictor for the current portion;
deriving a bit plane number indicating coded bit-planes by computing a sum of the bit plane number predictor and the signed integer variable; and
decoding the current portion from the data stream by use of the bit plane number.

2. The decoder of claim 1, wherein the decoder is configured to decode the signed integer variable from the data stream by use of the unary code if the integer valued variable falls within a first subinterval of a value range of the signed integer variable; and
wherein the decoder is configured to decode the signed integer variable, if the signed integer variable falls within a second subinterval of the value range of the signed integer variable, from the data stream by decoding magnitude and sign of the signed integer variable separately, wherein the magnitude is decoded by use of a further unary code, and separately decoding a sign bit, wherein none of the further unary code's codewords is prefix of any codeword of the unary code.

3. The decoder of claim 2, configured to decode the magnitude and sign of the signed integer variable from contiguous bits of the data stream or decode the magnitude and sign of the signed integer variable from different fragments of the data stream a first one of which is related to the magnitude, and a second one of which is related to the sign.

4. The decoder of claim 2, wherein the first subinterval is contiguous and comprises zero, and the second subinterval flanks the first subinterval on both sides of the first subinterval.

5. The decoder of claim 3, wherein the decoder is configured to decode the signed integer variable, if the signed integer variable falls within a third subinterval of the value range of the signed integer variable, from the data stream by decoding magnitude and sign of the signed integer variable separately, wherein the magnitude is decoded by use of a fixed length code prefixed with a codeword of which neither one of the codewords of the unary code and the further unary code is a prefix, followed by decoding a sign bit, wherein the first subinterval is contiguous and comprises zero, the second subinterval flanks the first subinterval on both sides of the first subinterval, and the third subinterval flanks the second subinterval on both outer sides of the second subinterval.

6. The decoder of claim 1, wherein the sequence of portions of the media are blocks of coefficients of a spectral decomposition of a picture.

7. The decoder of claim 6, wherein the spectral decomposition is a wavelet transform or a block-wise spectral transform based on trigonometric basis functions.

8. The decoder of claim 5, wherein the portions are blocks of spatially neighboring coefficients within subbands into which the picture is decomposed by the spectral transform.

9. The decoder of claim 5, wherein the decoder is configured to derive from the data stream for each of different sections of the spectral decomposition a hint as to which of a set of variable length code (VLC) alphabets to use for the decoding the signed integer variable of portions within the respective section, with at least one of the VLC alphabets involving the unary code.

10. The decoder of claim 9, wherein the VLC alphabets differ in cardinality of a set of possible values of the signed integer variable and/or in maximum codeword length.

11. The decoder of claim 9, wherein the different sections correspond to different subbands into which the picture is subdivided by the spectral decomposition.

12. The decoder of claim 1, wherein the unary code defines a subset of a VLC alphabet used for the decoding the signed integer variable from the data stream, wherein all VLC alphabet's codewords other than the codewords of the unary code comprise a concatenation of a unary codeword ending with a stop bit, followed by a sign bit.

13. The decoder of claim 1 configured to derive the bit plane number predictor for the current portion using spatial prediction.

14. The decoder of claim 1, wherein the decoder is configured to initiate an escape decoding mechanism with respect to subsequent portions of the media depending on the signed integer value.

15. The decoder of claim 14, wherein the decoder is configured to initiate the escape decoding mechanism with respect to subsequent portions of the media if the bit plane number derived is negative, and the series of codewords of increasing length are sequentially assigned to a set of possible values {0, . . . , ±a} of the signed integer variable such that the codewords' length assigned to the set increases from possible value 0 to possible value ‘a’ according to 0, −1, 1, . . . , −a, +a with ‘a’ being an integer number greater than 0.

16. The decoder of claim 14, configured to skip decoding the signed integer variable from the data stream for portions for which the escape decoding mechanism is initiated.

17. The decoder of claim 14, configured to, in the decoding the current portion from the data stream by use of the bit plane number, decode bits of bit planes with respect to the current portion from the data stream, which are indicated by the bit plane number, and skip decoding the bits of the bit planes from the data stream for portions for which the escape decoding mechanism is initiated.

18. The decoder of claim 17, configured to derive the bit plane number predictor for the current portion using spatial prediction along a prediction direction coinciding with a coding order along which the sequence of portions are ordered.

19. The decoder of claim 18, wherein the coding order traverses the portions row by row.

20. The decoder of claim 17, configured to derive the bit plane number predictor for the current portion using spatial prediction along a prediction direction, wherein the prediction direction is a column direction and a coding order along which the sequence of portions are ordered traverses the portions row by row.

21. The decoder of claim 1, configured to derive the bit plane number predictor for the portions using spatial prediction along a first prediction direction coinciding with a coding order along which the sequence of portions are ordered or along a second prediction direction, wherein the second prediction direction is a column direction and the coding order traverses the portions row by row, wherein the decoder decides, on a subband by subband basis, depending on the data stream, to use the first prediction direction or the second prediction direction for portions within the subbands.

22. The decoder of claim 14, configured to restrict the initiating the escape decoding mechanism with respect to subsequent portions of the media depending on the signed integer value to a proper subset of the portions.

23. The decoder of claim 22, configured so that the proper subset of the portions is distanced along a coding order along which the sequence of portions are ordered, by a predetermined number of portions coinciding, in number, with the subsequent portions with respect to which the escape decoding mechanism is initiated.

24. The decoder of claim 22, configured to derive the bit plane number predictor for the current portion using spatial prediction along a prediction direction, wherein the prediction direction is a column direction and a coding order along which the sequence of portions are ordered traverses the portions row by row, and wherein the proper subsets of the portions form mutually vertically aligned portions, wherein the decoder is configured to perform the decoding the signed integer variable, the deriving the bit plane number predictor and the deriving the bit plane number with respect to the proper subset of portions at a first fragment of the data stream which precedes a second fragment of the data stream at which the decoder performs the decoding and deriving for portions external to and subsequent—in terms of the coding order—to said proper subset of portions.

25. The decoder of claim 1, configured to perform the decoding the signed integer variable, the deriving the bit plane number predictor and the deriving the bit plane number with respect to the sequence of portions at a bit plane number indication fragment of the data stream which precedes a bit plane indication fragment of the data stream at which the decoder performs the decoding the portions.

26. An encoder for encoding a sequence of portions of media into a data stream by:
deriving a bit plane number predictor for a current portion;
deriving a bit plane number indicating coded bit-planes for the current portion and setting a signed integer variable so that the bit plane number is derivable from a sum between the bit plane number predictor and the signed integer variable; and
encoding, for the current portion, the signed integer variable into the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs from a second length of a second codeword of the unary code assigned to a second possible value
having a second sign and the predetermined absolute value, or
being zero with the predetermined absolute value being one,
by exactly one;
encoding the current portion into the data stream by use of the bit plane number.

27. The encoder of claim 26, wherein the encoder is configured to encode the signed integer variable into the data stream by use of the unary code if the integer valued variable falls within a first subinterval of a value range of the signed integer variable; and
wherein the encoder is configured to encode the signed integer variable, if the signed integer variable falls within a second subinterval of the value range of the signed integer variable, into the data stream by encoding magnitude and sign of the signed integer variable separately, wherein the magnitude is encoded by use of a further unary code, and separately encoding a sign bit, wherein none of the further unary code's codewords is a prefix of any codeword of the unary code.

28. The encoder of claim 26 configured to encode the magnitude and sign of the signed integer variable into contiguous bits of the data stream or to encode the magnitude and sign of the signed integer variable into different fragments of the data stream, a first one of which is related to the magnitude, and a second one of which is related to the sign.

29. The encoder of claim 26, wherein the first subinterval is contiguous and comprises zero, and the second subinterval flanks the first subinterval on both sides of the first subinterval.

30. The encoder of claim 29, wherein the encoder is configured to encode the signed integer variable, if the signed integer variable falls within a third subinterval of the value range of the signed integer variable, into the data stream by coding magnitude and sign of the signed integer variable separately, wherein the magnitude is encoded by use of a fixed length code prefixed with a codeword of which neither one of the codewords of the unary code and the further unary code is a prefix, followed by encoding a sign bit, wherein the first subinterval is contiguous and comprises zero, the second subinterval flanks the first subinterval on both sides of the first subinterval, and the third subinterval flanks the second subinterval on both outer sides of the second subinterval.

31. The encoder of claim 26, wherein the sequence of portions of the media are blocks of coefficients of a spectral decomposition of a picture.

32. The encoder of claim 31, wherein the spectral decomposition is a wavelet transform or a block-wise spectral transform based on trigonometric basis functions.

33. The encoder of claim 31, wherein the portions are blocks of spatially neighboring coefficients within subbands into which the picture is decomposed by the spectral transform.

34. The encoder of claim 31, wherein the encoder is configured to provide in the data stream for each of different sections of the spectral decomposition a hint which of a set of variable length code (VLC) alphabets is used for encoding the signed integer variable of portions within the respective section, wherein at least one of the VLC alphabets involves the unary code.

35. The encoder of claim 34, wherein the VLC alphabets differ in cardinality of a set of possible values of the signed integer variable and/or in maximum codeword length.

36. The encoder of claim 34, wherein the different sections correspond to different subbands into which the picture is subdivided by the spectral decomposition.

37. The encoder of claim 26, wherein the unary code defines a subset of a VLC alphabet used for the encoding the signed integer variable from the data stream, wherein all VLC alphabet's codewords other than the codewords of the unary code comprise a concatenation of a unary codeword ending with zero, followed by a sign bit.

38. The encoder of claim 26 configured to derive the bit plane number predictor for the current portion using spatial prediction.

39. The encoder of claim 26, wherein the encoder is configured to initiate an escape encoding mechanism with respect to subsequent portions of the media depending on the signed integer value.

40. The encoder of claim 39, wherein the encoder is configured to initiate the escape encoding mechanism with respect to subsequent portions of the media if the bit plane number derived is negative, and the series of codewords of increasing length are sequentially assigned to a set of possible values {0, . . . , ±a} of the signed integer variable such that the codewords' length assigned to the set increases from possible value 0 to possible value ‘a’ according to 0, −1, 1, . . . , −a, +a with ‘a’ being an integer number greater than 0.

41. The encoder of claim 39, configured to skip encoding the signed integer variable into the data stream for portions for which the escape encoding mechanism is initiated.

42. The encoder according of claim 39, configured to, in the encoding the current portion into the data stream by use of the bit plane number, encode bits of bit planes with respect to the current portion into the data stream, which are indicated by the bit plane number, and skip encoding the bits of the bit planes into the data stream for portions for which the escape encoding mechanism is initiated.

43. The encoder of claim 42, configured to derive the bit plane number predictor for the current portion using spatial prediction along a prediction direction coinciding with a coding order along which the sequence of portions are ordered.

44. The encoder of claim 43, wherein the coding order traverses the portions row by row.

45. The encoder of claim 43, configured to derive the bit plane number predictor for the current portion using spatial prediction along a prediction direction, wherein the prediction direction is a column direction and a coding order along which the sequence of portions are ordered traverses the portions row by row

46. The encoder of claim 42, configured to derive the bit plane number predictor for the portions using spatial prediction along a first prediction direction coinciding with a coding order along which the sequence of portions are ordered or along a second prediction direction, wherein the second prediction direction is a column direction and the coding order traverses the portions row by row, wherein the encoder decides, on a subband by subband basis, to use the first prediction direction or the second prediction direction for portions within the subbands and signal the decision in the data stream.

47. The encoder of claim 39, configured to restrict the initiating the escape encoding mechanism with respect to subsequent portions of the media to a proper subset of the portions.

48. The encoder of claim 47, configured so that the proper subset of the portions is distanced along a coding order along which the sequence of portions are ordered, by a predetermined number of portions coinciding, in number, with the subsequent portions with respect to which the escape encoding mechanism is initiated.

49. The encoder of claim 47, configured to derive the bit plane number predictor for the current portion using spatial prediction along a prediction direction, wherein the prediction direction is a column direction and a coding order along which the sequence of portions are ordered traverses the portions row by row, and the proper subset of the portions form mutually vertically aligned portions, wherein the encoder is configured to perform the encoding the signed integer variable, the deriving the bit plane number predictor and the deriving the bit plane number with respect to the proper subset of portions at a first fragment of the data stream which precedes a second fragment of the data stream at which the encoder performs the encoding and deriving for portions external to and subsequent—in terms of the coding order—to said proper subset of portions.

50. The encoder of claim 26, configured to perform the encoding the signed integer variable, the deriving the bit plane number predictor and the deriving the bit plane number with respect to the sequence of portions at a bit plane number indication fragment of the data stream which precedes a bit plane indication fragment of the data stream at which the encoder performs the encoding the portions.

51. A method for decoding a sequence of portions of media from a data stream, the method comprising the steps of:
decoding, for a current portion, a signed integer variable from the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs from a second length of a second codeword of the unary code assigned to a second possible value
having a second sign and the predetermined absolute value, or
being zero with the predetermined absolute value being one,
by exactly one;
deriving a bit plane number predictor for the current portion;
deriving a bit plane number indicating coded bit-planes by computing a sum of the bit plane number predictor and the signed integer variable; and
decoding the current portion from the data stream by use of the bit plane number.

52. A method for encoding a sequence of portions of media from a data stream, the method comprising the steps of:
deriving a bit plane number predictor for a current portion;
deriving a bit plane number indicating coded bit-planes for the current portion and setting a signed integer variable so that the bit plane number is derivable from a sum between the bit plane number predictor and the signed integer variable; and
encoding, for the current portion, the signed integer variable into the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs from a second length of a second codeword of the unary code assigned to a second possible value
having a second sign and the predetermined absolute value, or
being zero with the predetermined absolute value being one,
by exactly one;
encoding the current portion into the data stream by use of the bit plane number.

53. A computer readable digital storage medium having stored thereon a computer program having a program code for performing, when running on a computer, a method for decoding a sequence of portions of media from a data stream, the method comprising the steps of:
decoding, for a current portion, a signed integer variable from the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs from a second length of a second codeword of the unary code assigned to a second possible value
having a second sign and the predetermined absolute value, or
being zero with the predetermined absolute value being one,
by exactly one;
deriving a bit plane number predictor for the current portion;
deriving a bit plane number indicating coded bit-planes by computing a sum of the bit plane number predictor and the signed integer variable; and
decoding the current portion from the data stream by use of the bit plane number.

54. A computer readable digital storage medium having stored thereon a computer program having a program code for performing, when running on a computer, a method for encoding a sequence of portions of media from a data stream, the method comprising the steps of:
deriving a bit plane number predictor for a current portion;
deriving a bit plane number indicating coded bit-planes for the current portion and setting a signed integer variable so that the bit plane number is derivable from a sum between the bit plane number predictor and the signed integer variable; and
encoding, for the current portion, the signed integer variable into the data stream by use of a unary code comprising a series of codewords of increasing length which are sequentially assigned to possible values of the signed integer variable in a manner so that a first possible value having a first sign and a predetermined absolute value has assigned a first codeword of the unary code of a first length which differs from a second length of a second codeword of the unary code assigned to a second possible value
having a second sign and the predetermined absolute value, or
being zero with the predetermined absolute value being one,
by exactly one;
encoding the current portion into the data stream by use of the bit plane number.
